(19) United States
(12) Patent Application Publication
(10) Pub. No.: US 2008/0176655 A1
(43) Pub. Date: Jul. 24, 2008

(54) System and Method for Implementing an Interactive Online Community Utilizing an Activity Monitor

(76) Inventors: Terry L. James, Fairview, TX (US); Grant K. James, Fairview, TX (US)

Correspondence Address: BAKER BOTTS L.L.P., 2001 ROSS AVENUE, SUITE 600, DALLAS, TX, 75201-2980, US

(21) Appl. No.: 11/625,063

(22) Filed: Jan. 19, 2007

(51) Int. Cl. G06F 17/00

(52) U.S. Cl. 463/42; 600/301

(57) ABSTRACT

An interactive online community utilizes an activity monitor that is operable to measure data, transmit data, and receive data. One or more servers coupled to a communication network provide access to the World Wide Web (“web”). A web portal located on one or more servers is operable to transmit data to the activity monitor and receive data from the activity monitor. The web portal includes a gaming and communication environment that utilizes the data from the activity monitor. Users engage in physical activity and participate in the gaming and communication environment with other users.

### TECHNICAL FIELD OF THE INVENTION

This invention relates in general to a web portal and, more particularly, to a system and method for implementing an interactive online community utilizing an activity monitor.

### BACKGROUND OF THE INVENTION

Obesity increases the risk of many diseases and health conditions, including diabetes, asthma, hypertension, gallbladder disease, high cholesterol, osteoarthritis, and heart disease. Thirty percent of adults in the United States that are twenty years or older are obese. The same obesity-related diseases and health conditions are becoming more common in younger people as well. The percentage of young people who are overweight has more than tripled since 1980. The percentage of obese children and adolescents is at an all time high. Inactivity and sedentary behavior are among the biggest contributors to the increase of obesity in children, adolescents, and adults.

The United States Surgeon General recommends moderate physical activity for children once a day for at least sixty minutes. Moderate and regular physical activity is good for a person's overall health. Physical activity decreases the risk for cancers, diabetes, high blood pressure, high cholesterol levels, and arthritis. Physical activity also helps control a person's weight which also positively affects a person's general well being. Physical activity is any bodily movement that results in an expenditure of calories. Moderate physical activity is enough. Physical activity does not have to be strenuous to provide benefits to a person's health.

People need an incentive to engage in physical activity. Simply referring the general population to the latest medical literature on the risks associated with obesity is not a viable solution. An individual's incentives to engage in physical activity can vary and include: maintaining weight, socializing with friends, or competing against your peers. Current activity monitors allow individuals to track a primary metric, but this rudimentary measurement feature alone does not provide enough incentive for most individuals to engage in physical activity. People may make physical activity decisions based on their community or environment. A person is more likely to become physically active if they are able to interact with their peers in a community. Additionally, a person is more likely to engage in physical activity and sustain that activity if the person is drawn into an environment that creates an incentive to stay active.

As technology has increased over the past few decades, people have become even less physically active while obesity has grown to epidemic proportions. In the past, people had an incentive to engage in physical activity by socializing with others while attending an aerobics class, going on a walk with a friend, playing sports, etcetera. Now, people tend to socialize with one another in online communities rather than real world locations. The incentive to engage in physical activity for social reasons has been severely diminished in the modern world. Additionally, a large population of children and adults have little incentive to be physically active because they are playing interactive video games which requires very little physical activity. People need a modern incentive to engage in physical activity.

While obesity has climbed to alarming levels, the gaming community has exploded. In the past thirty years, several gaming systems have been developed with new generation gaming systems being developed every few years including Atari™, Sega™, Nintendo™, Playstation™, Game Boy™, XBOX™, and personal computers. Now, games running on these gaming systems are connected to the Internet and allow users to interact in gaming communities while competing against their peers. A large population of gamers made up of children, adolescents, and adults are addicted to these new generation gaming communities, which tends to cause sedentary behavior in gamers. The population of obese people has steadily grown along with the growth of the gaming population. Providing an incentive to engage in physical activity for two diverse communities, the habitually overweight and the fanatical, sedentary gamers of the 21^{st} century, presents a significant challenge and immense opportunity for those relegated to the onerous task of controlling the population's health.

### SUMMARY OF THE INVENTION

In accordance with the present invention, a method and a system for providing an interactive online community is provided, which substantially eliminates or reduces the disadvantages and problems associated with previous systems and methods.

In one embodiment of the present invention, a method for providing an activity monitor is offered that is operable to measure data, transmit data, and receive data. The method also includes one or more servers coupled to a communication network providing access to the World Wide Web (“web”). The method further includes a web portal located on one or more servers operable to transmit data to the activity monitor and receive data from the activity monitor. The web portal includes a gaming and communication environment that utilizes the data from the activity monitor. The method also includes users participating in the gaming and communication environment with other users.

In a more particular embodiment, the gaming environment enables users to compete with other users and to select rules for a game. The web portal receives data from the activity monitor during the game. The server utilizes an algorithm to determine a result in terms of win, lose, tie, or placement based on data from the activity monitor. The server utilizes one or more algorithms to calculate a user's rank, experience points, and level at the end of a game. Additionally, the user may receive a reward (of some form) or trophy at the end of the game.

Important technical advantages of certain embodiments of the present invention include engaging the user in physical activity to enhance the user's experience in the communication and gaming environment. In the gaming environment, the present invention uses rank, level, goals, rewards, trophies, currency, and leader boards to engage users in physical activity. In the communication environment, the present invention enables the user to create a social network of friends to engage in physical activity. Users can search and meet new friends based on physical activity preferences, or based on similar demographics. The users can also view other users' web pages including other users' physical activity information, which fosters a competitive environment. Additionally, users can message other users and challenge other users to participate in a game utilizing the activity monitor. The present invention further enables users to customize their web pages to display how features are displayed and where features are displayed.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram that illustrates a system for an interactive online community to utilize data from an activity monitor in accordance with a particular embodiment of the present invention;

FIG. 2 is a simplified block diagram that illustrates the features of the gaming and communication environment on the web portal in accordance with a particular embodiment of the present invention;

FIG. 3A is a simplified flowchart that illustrates an example method of an active variable driven game in accordance with an embodiment of the present invention;

FIG. 3B is a simplified flowchart that illustrates an example method of a passive variable driven game in accordance with an embodiment of the present invention;

FIG. 3C is a simplified flowchart that illustrates an example method of a translation driven game in accordance with an embodiment of the present invention;

FIG. 4A is an example of a user's website in accordance with an embodiment of the present invention;

FIG. 4B is an example of a friends feature displayed on a user's website in accordance with an embodiment of the present invention;

FIG. 4C is an example of a trophy case feature displayed on a user's website in accordance with an embodiment of the present invention;

FIG. 4D is an example of a message feature displayed on a user's website in accordance with an embodiment of the present invention;

FIG. 4E is an example of an instant message feature displayed on a user's website in accordance with an embodiment of the present invention;

FIG. 4F is an example of a goal feature displayed on a user's website in accordance with an embodiment of the present invention;

FIG. 4G is an example of a leader board displayed on a user's website in accordance with an embodiment of the present invention;

FIG. 5 is a simplified flowchart that illustrates an example method of the goal feature in accordance with an embodiment of the present invention;

FIG. 6 is a simplified flowchart that illustrates an example method of the activity zones feature in accordance with an embodiment of the present invention;

FIG. 7A is an example of a user's website in accordance with an embodiment of the present invention;

FIG. 7B is an example of an edit profile feature displayed on a user's website in accordance with an embodiment of the present invention;

FIG. 7C is an example of a vertical widget of a trophy case feature displayed on a user's website in accordance with an embodiment of the present invention;

FIG. 7D is an example of a horizontal widget of a trophy case feature displayed on a user's website in accordance with an embodiment of the present invention;

FIG. 7E is an example of a square widget of a trophy case feature displayed on a user's website in accordance with an embodiment of the present invention;

FIG. 7F is an example of a search feature displayed on a user's website in accordance with an embodiment of the present invention;

FIG. 7G is an example of a search feature displayed on a user's website in accordance with an embodiment of the present invention;

FIG. 7H is an example of a search feature displayed on a user's website in accordance with an embodiment of the present invention; and

FIG. 7I is an example of a search feature displayed on a user's website in accordance with an embodiment of the present invention.

### DETAILED DESCRIPTION OF THE INVENTION

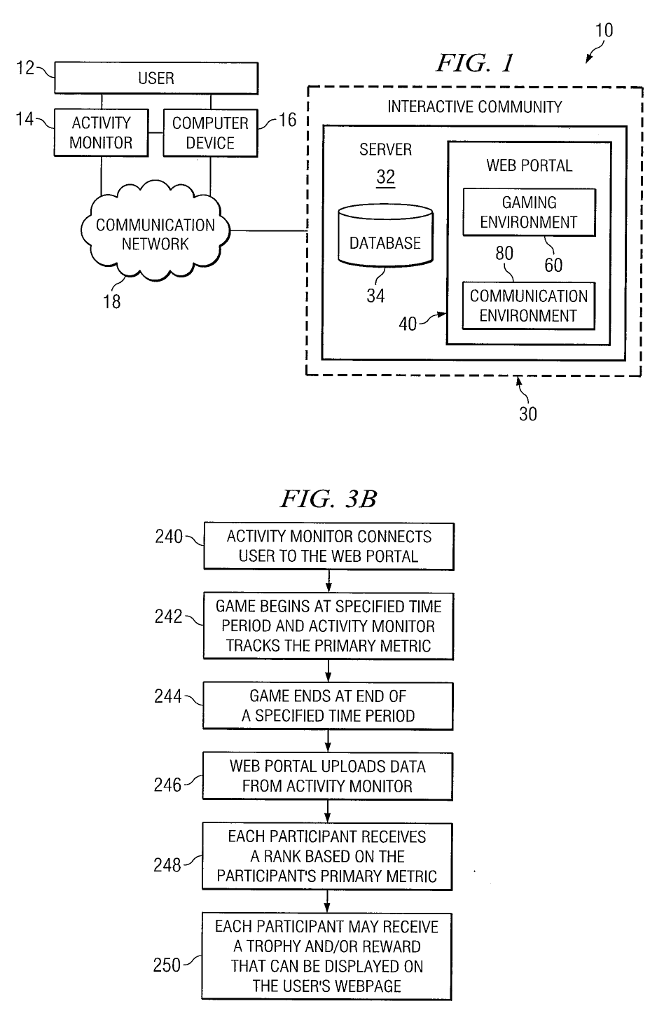

FIG. 1 illustrates a system 10 for offering an interactive online community to utilize data from an activity monitor 14 in accordance with a particular embodiment of the present invention. System includes a communication network 18, one or more users 12, one or more computer devices 16, one or more activity monitors 14, and an interactive community 30. Interactive community 30 includes one or more servers 32, one or more databases 34, and a web portal 40. Web portal includes a gaming environment 60 and a communication environment 80. Other architectures and components of system 10, including various architectures and components of interactive community 30, may be used without departing from the scope of this disclosure.

In general, users 12 can wear an activity monitor 14 to track a primary metric. Users 12 can couple activity monitor 14 to a computer device 16, which provides the users access to the interactive community 30. Activity monitor 14 can transmit data to interactive community 30 and receive data from interactive community 30. Interactive community 30 provides users 12 a web portal 40 with customizable web pages. The interactive community 30 allows users 12 to participate in a sophisticated gaming environment 60 utilizing the data received from user's activity monitor 14. Additionally, interactive community 30 allows users 12 to communicate with other users 12 in a sophisticated communication environment 80.

Communication network 18 couples and facilitates wireless or wire line communication between computer devices 16, activity monitors 14, and servers 32. Communication network 18 may, for example, communicate Internet Protocol (IP) packets, Frame Relay frames, Asynchronous Transfer Mode (ATM) cells, voice, video, data, and other suitable information between network addresses. Communication network 18 may also communicate data via wireless communications, such as by Wireless Application Protocol (WAP) standard protocols, including 802.11, third-generation (3G) protocols (such as W-CDMA or CDMA 2000, for example), Bluetooth, or Global System for Mobile Communications (GSM) protocols, for example. Communication network 18 may include one or more local area networks (LANs), radio access networks (RANs), metropolitan area networks (MANs), wide area networks (WANs), interactive television networks, all or a portion of the global computer network known as the Internet, and/or any other communication system or systems at one or more locations.

Users 12 may include any individual, group, or business entity desiring to use an activity monitor 14 or a computer device 16 to access interactive community 30. Users 12 may wear activity monitors 14 and couple activity monitors 14 to computer devices 16 to connect to interactive community 30. Some users 12 might not wear activity monitors 14, but these users 12 may monitor the activity data of one or more users 12 by accessing and viewing interactive community 30. For example, user 12 may be a physical education instructor who uses the computer device 16 to create a curriculum on the interactive community 30 that utilizes the activity monitor 14. Users 12 may also include physical education students who couple their activity monitors 14 to computer device 16 to transmit the data from activity monitor 14 to interactive community 30. Interactive community 30 allows teachers to view the physical activity data of their students and use this information to grade the students according to the curriculum.

In another embodiment, user 12 may be a business entity that utilizes activity monitor 14 to attract potential users to the business. Activity monitor 14 may provide helpful information to user about the business. Activity monitor 14 can grant users 12 access to the business's web portal 40 that serves as an online business center. Multiple forms of communication and information can be passed from the business to users 12 via interactive community 30. Activity monitor 14 will engage users to visit the business's web portal 40.

In another embodiment, users 12 may include one or more doctors and one or more patients such that doctors can utilize interactive community 30 and activity monitors 14 to provide treatment to patients. Patients may wear activity monitor 14 and transmit their physical activity data to interactive community 30. Doctors can access and monitor their patients' daily physical activity data. Doctors can also view the patients' participation in gaming environment 60 and communication environment 80, and view the patients' rank, level, and experience points.

In another embodiment, users 12 may include animals or pets, such that owners or trainers can monitor activity level of animal, and monitor progress of animal's training.

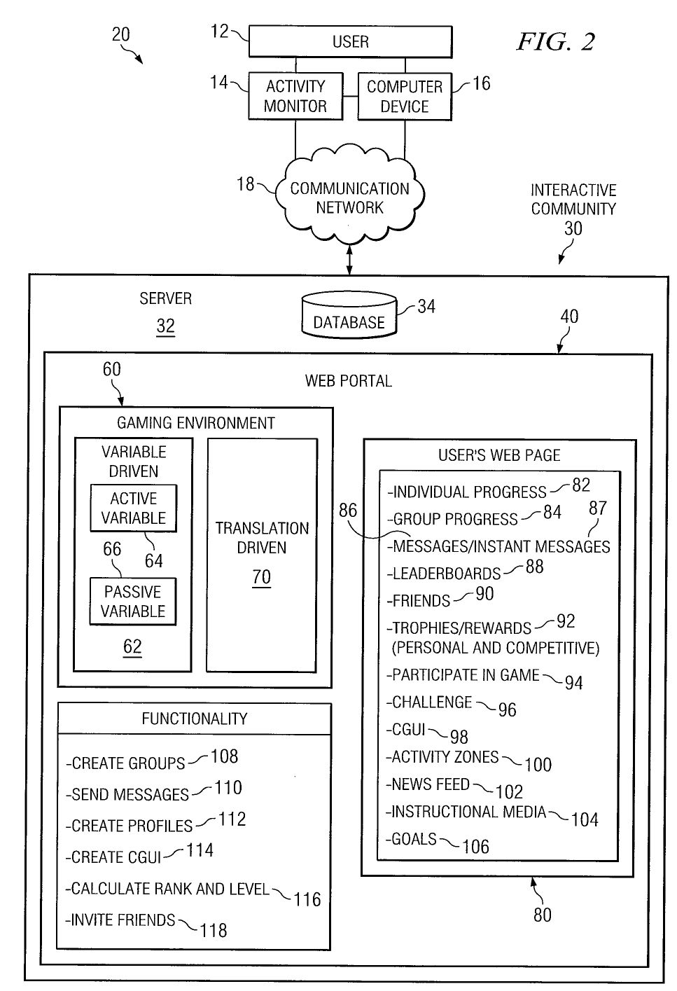

Activity monitors 14 are generally operable to measure body movement of a user, store data, receive data, transmit data, display data, and convert data for a multitude of purposes. Activity monitor is operable to monitor and display counter data, such that user enters the number of pills or vegetables consumed, or any other trackable data. Activity monitor stores this information as counter data. Activity monitor is operable to monitor and display game statistics. Activity monitor is further operable to display any data received from web portal. Details on data stored on web portal are below in FIG. 2. For example, activity monitor 14 may measure and display a primary metric that includes calories, distances, points, life zone minutes, health zone minutes, sports zone minutes, counter data, or game statistics. User 12 can wear activity monitor 14 for an entire day or only for an event for a specified period of time. Memory in activity monitor 14 may include volatile or non-volatile memory including, without limitation, magnetic media, optical media, random access memory (RAM), read-only memory (ROM), removable media, or any other suitable local or remote memory component. In general, the memory may store various data including metrics, a user's account information, and a user's weight, height, and sex in any suitable format. Activity monitor 14 is operable to receive data from interactive community 30, computer device 16, or any other device connected to communication network 18. Activity monitor 14 is further operable to transmit data to interactive community 30, computer device 16, or any other device connected to communication network 18. Activity monitor 14 may include a graphics card to display streaming video and data stored in memory. Activity monitor 14 may include a processor to convert data and utilize algorithms. For example, activity monitor 14 may apply an algorithm to convert distance traveled into calories burned by utilizing data from the memory like a user's height, weight, and sex. Activity monitor 14 is further operable such that activity monitor 14 can be disabled from displaying data, from transmitting data, and from receiving data. A feature of the present invention includes a subscription model that may include users paying to use interactive community 30 and to use activity monitor 14. If user 12 is delinquent in subscription payments, activity monitor 14 may be disabled and access to interactive community 30 may be blocked.

Computer devices 16 may comprise computer systems that include appropriate input devices, output devices, mass storage media, processors, memory, or other components for receiving, processing, storing, and/or communicating information with other components of system 10. As used in this document, the term “computer” is intended to encompass a personal computer, workstation, network computer, wireless data port, wireless telephone, personal digital assistant (PDA), cellular telephone, game console, one or more processors within these or other devices, or any other suitable processing device. It will be understood that any number of computer devices 16 may be coupled to communication network 18. Computer devices 16 are generally operated by users 12 or coupled with activity monitors 14 to access the interactive community.

A particular computer device 16 may comprise a browser application, such as an Internet web browser, for example. Browser application may allow user 12 of computer device 16 to navigate through, or “browse,” various Internet web sites or web pages. Computer device 16 may also comprise one or more graphics applications, such as a FLASH™ application for example, operable to display various types of data received via communication network 18, such as graphics, video, and streaming data (such as video and/or audio), for example.

A particular activity monitor 14 can be coupled to computer device 16 such that user 12 can access the web portal in interactive community 30 without intervention from a third party (for example, a webmaster forwarding information). Activity monitor 14 functions as a digital key to web portal 40 so that users instantly access web portal 40 without having to launch an Internet web browser or type in a username or password. The user will be able to instantly interact with other users in gaming 60 and communication environment 80.

Interactive community 30 generally includes one or more servers 32, one or more databases 34, and web portal 40. Web portal 40 includes gaming environment 60 and communication environment 80 that utilize data from the activity monitors 14. Other architectures and components of interactive community 30 may be used without departing from the scope of this disclosure.

Software and/or hardware may reside in interactive community 30 in order to achieve the teachings of collecting data, converting data, displaying data, and communicating data of the present invention. However, due to their flexibility, interactive community 30 may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of interactive community 30 in the context of communication system 10 and, accordingly, it should be construed as such.

Servers 32 are generally operable to provide an interface between users 12 and interactive community 30. One or more servers 32 may be web application servers or simple processors operable to allow users 12 to participate in interactive community 30 via the communication network 18 using a standard user interface language such as, for example, the HyperText Markup Language (HTML). In some embodiments, one or more servers 32 may be physically distributed such that each server 32, or multiple instances of each server 32, may be located in a different physical location geographically remote from each other. In other embodiments, one or more servers 32 may be combined and/or integral to each other. One or more servers 32 may be implemented using a general purpose personal computer (PC), a Macintosh, a workstation, a UNIX-based computer, a server computer, or any other suitable processing device.

In some embodiments, servers 32 are operable to provide security and/or authentication of users 12 or other persons or entities attempting to access interactive community 30. For example, servers 32 may essentially provide a firewall for entities attempting to access interactive community 30. In addition, servers 32 may be operable to translate one or more data protocols used by interactive community 30 with one or more protocols used by applications hosted by one or more computer devices 16.

In particular embodiments, one or more servers 32 are web application servers operable to communicate dynamically updated information to particular computer devices 16 via communication network 18. For example, one or more servers 32 may communicate dynamically updated information on interactive community 30 to particular computer devices 16 or activity monitors 14 via communication network 18.

Servers 32 further comprises a memory that may be accessed or otherwise utilized by one or more components of interactive community. The memory may take the form of volatile or non-volatile memory including, without limitation, magnetic media, optical media, random access memory (RAM), read-only memory (ROM), removable media, or any other suitable local or remote memory component. In general, the server memory may store various data including a user's account information, gaming environment data, and communication environment data in any suitable format.

Databases 34 are operable to store various data associated with interactive community 30, such as information regarding users 12, computer devices 16, activity monitors 14, gaming environments 60, and communication environments 80 for example. Databases 34 may communicate with servers 32 such that servers 32 may store information, retrieve information, and share information with each other. Databases 34 may provide a backup in the case of outages or other failures of various components of interactive community 30.

Web portal 40 comprises a means to transmit information to server, one or more web sites, and software and hardware that provide users of the web with the ability to search for information on the web including information in the interactive community 30, documents, media, or other resources coupled to the web. The means for transmitting information to server can include SOAP calls, FTP, HTTP, HTTPS, Batch File Uploads, PHP, ASP, .NET, Java Script, or any other suitable means for transmitting data from one computer to another. Web portal 40 can utilize Web Services that access port 21, 80, or any other server port. Web portal 40 can transmit data to server 32 by a web browser or any other suitable means for transmitting data to server 32. The web sites on web portal 40 may include user's websites, leader board websites 88, informational websites 104, and gaming environment websites 60. Web portal 40 provides a central location for users 12 of interactive community 30 utilizing activity data to get together with each other. Web portal 40 engages physical activity from users 12 because users 12 have a central location for conversing with their peers, who are also physically active. Web portal can be thought of as a watering hole where users congregate.

Gaming environment 60 includes games utilizing data from activity monitor 14 including games stored on computer device 16 connected to interactive community 30 and/or games stored on interactive community 30. Gaming environment 60 enables users 12 to participate in games by utilizing the data from activity monitor 14 including solo games, one-versus-one games, free-for-all games such that one or more users compete against one another, team-versus-team games such that a team is one or more users, and world environment games such that a plurality of users interact with each other. Gaming environment 60 includes variable driven games 62 and translation driven games 70. Variable driven games 62 include active variable games 64 and passive variable games 66. Variable driven games 62 utilize data from activity monitor 14 to decide the outcome of a game. For example, a winner in a one on one game may be decided by comparing which user 12 was more active during a specified time period. Translation driven games 70 utilize data from activity monitor 14 such that user 12 can convert a primary metric from activity monitor 14 into a digital currency for user 12 to utilize in gaming environment 60. The digital currency is a stored data value that can be utilized in gaming environment 60. The digital currency can be spent on gaming elements to help user 12 succeed in gaming environment 60. For example, user 12 may convert activity data into currency that is spent on gasoline for a race car game. Gaming environment 60 engages users 12 to be active and wear activity monitor 14 because users 12 want to compete against their peers and succeed in games utilizing the activity data.

Communication environment 80 comprises displays and features in interactive community 30 that utilizes data from activity monitor 14. Communication environment 80 comprises one or more displays including a user's profile, a user's picture, a user's progress 82, a group's progress 84, messages from other users 86, instant messages from other users 87, leader boards 88, picture and profile of friends 90, a trophy case 92, activity zones 100, a news feed 102, instructional media 104, and goals 106. Communication environment 80 also comprises one or more features operable to create a customizable graphic user interface (“CGUI”) 114, to create a user profile 112, to create a group 108, to invite friends to group 118, to send and receive messages 110, and to send and receive instant messages 110. Communication environment 30 motivates users 12 to be active and to wear activity monitor 14 because users are inclined to view the status of personal goals 106 and friend's goals 106, to share dieting and activity experiences with other users, to view instructional media 104 and news feeds 102, and to generally interact with their friends.

FIG. 2 illustrates the features of interactive community 30, including gaming environment 60 and communication environment 80 in accordance with a particular embodiment of the present invention. Interactive community 30 includes one or more servers 32, one or more databases 34, and web portal 40. Web portal 40 includes gaming environment 60 and communication environment 80. Gaming environment 60 includes variable driven games 62 and translation driven games 70. Variable driven games 62 include active variable games 64 and passive variable games 66. Communication environment 80 includes intelligence for displaying a user's progress 82, a group's progress 84, messages 86, instant messages 87, leader boards 88, friends 90, profiles, trophy cases 92, rewards 92, activity zones 100, news feeds 102, instructional media 104, goals 106, record holders 170, monthly leader 176, yesterday's top point leaders 178, new users 180, and announcements 182. Interactive community 80 allows users 12 to create a customizable graphic user interface (“CGUI”) 114 so that user 12 can change the way graphics and features are displayed on their user website. Edit Profile allows users to customize user bios 152, upload pictures and videos 154, profile layouts 156, color schemes 158, profile skins 160, transitions 162, wallpaper 164, special effects 166, and privacy settings 168. Customized displays can also include sporting team themes, video game themes, and movie themes. Interactive community 30 has other features, including intelligence for inviting friends 118, creating and editing profiles 150, creating groups 108, sending and receiving messages 110, sending and receiving instant messages 110, challenging users to games 96, participating in a game 94, calculating rank 116, level, and experience points, shopping at an online store 172, and searching for friends 174. Other architectures and components of interactive community 30, may be used without departing from the scope of this disclosure.

Gaming environment 60 comprises games utilizing data from activity monitor 14, including games stored on computer device 16 connected to interactive community 30, games stored on interactive community 30, and games stored on a third party's website connected to interactive community 30. Gaming environment 60 is operable for users 12 to participate in games by utilizing the data from activity monitor 12 including solo games, one-versus-one games, free-for-all games such that one or more users 12 compete against one another, team-versus-team games such that a team is one or more users 12, and world environment games such that a plurality of users 12 interact with each other. Gaming environment 60 engages users to be active and to wear activity monitor 14 because users 12 want to compete against their peers or succeed in games utilizing the activity data.

Variable driven games 62 are operable to utilize data from activity monitor 14 to decide the outcome of a game. Variable driven games 62 include active variable driven games 64 and passive variable driven games 66. User 12 must elect or sign up to participate in an active variable driven game 64. Conversely, passive variable driven games 66 are running continuously regardless if user 12 signs up to participate. All users 12 in population, group, or subgroup can be part of variable driven games 66.

Active variable driven games 64 are operable to utilize one or more primary metrics from activity monitor 14. A primary metric can include steps, distance, calories, points, life zone minutes, health zone minutes, and sport zone minutes. Interactive community is operable for users 12 to create the games through web portal 40. Users 12 can invite other users 12 to join the game or users 12 can join the game on their own. Users 12 set rules and select a specified time period of when the game will begin and when the game will end. For example, the rules can include the first user 12 to reach 1,000 steps, burn 500 calories, or run a mile in the shortest time. Active variable driven games 64 begin at the start of the specified time period and finish at the end of the specified time period. User 12 participation begins when user 12 wears the activity monitor 14. Activity monitor 14 is operable to store the activity data and to transmit the data to gaming environment 60 in interactive community 30. One or more proprietary algorithms utilize each user's primary metrics to decide a result of variable driven game 62. Results can include win, place, tie, or placement. Results can include win, place, or tie for team-versus-team games and one-versus-one games. A team can be one or more users 12. Results can include a placement result for a free-for-all game involving a plurality of users 12 or teams competing against one another. For example, in a free-for-all game of nine teams, the team that finishes first will receive a first placement and the team that finishes ninth will receive a ninth placement. In active variable driven games 64, one or more proprietary algorithms utilizing one or more primary metric variables will decide a user's experiences points, level, and rank in both global and specific game leader boards 88. Users 12 want to achieve a rank and level higher than their peers which creates an incentive for users to engage in physical activity.

Celebrity race is an example of an active variable driven game 64. Celebrity race involves someone famous who uses an activity monitor 14. Users 12 can compete against the celebrity for a fixed amount of time for a selected primary metric. Users 12 may receive a reward if user 12 can obtain more points than celebrity in the fixed amount of time. Users 12 will have an incentive to be active so that user can brag about being more active than a famous celebrity.

Tug of war is an example of an active variable driven game 64. Tug of war is divided into two teams, and the first team to record a certain number of points wins.

King of the hill is an example of an active variable driven game 64. King of the hill is a free for all game, and the user 12 who stays on stop of the mountain the longest at the end of the specified time period wins. Other users 12 can knock the leader off the hill by getting more points than everyone else for the day.

Marathon is an example of an active variable driven game 46. Marathon is for one or more users, and the user 12 who reaches the set total amount of the primary metric first will be declared the winner.

Housewife game is an example of an active variable driven game 46. Housewife game caters to users 12 who are active in the life zone minutes, and the winner is the user who obtains the most life zone minutes within the specified time period. This gives incentives for users 12 who are active in life zone minutes to compete and stay active.

Passive variable driven games 66 are operable to utilize a primary metric from activity monitor 14. A primary metric can include steps, distance, calories, points, life zone minutes, health zone minutes, and sport zone minutes. The interactive community is operable to automatically create passive variable driven games. Users 12 can also create passive variable games 66 through web portal 40. The outcome of passive variable driven game 80 is based on a primary metric over a specified period of time. The specified time period in a passive variable game usually comprises a day, week, month, or year. At the end of the specified time period, a rank will be given for each user 12 based on the primary metric totals. For example, passive variable driven 66 game may last for six months based on the total number of calories burned. User 12 who burns 120,000 calories during the six month period will receive a better rank than a user 12 who burns 90,000 calories during the six month period. Users 12 want to achieve a rank higher than their peers which creates an incentive for users 12 to engage in physical activity.

Translation driven games 70 utilize data from activity monitor 14 such that user 12 can convert a primary metric from an activity monitor 14 into a digital currency for user 12 to utilize in gaming environment 60. The digital currency is a stored data value that can be utilized in gaming environment 60. The digital currency can be spent on gaming elements to help a user succeed in gaming environment 60. For example, user 12 may convert 1,000 calories burned into currency that can be spent to buy twenty gallons of gasoline for a race car game. In another embodiment, user 12 may convert 1,000 steps into currency that can be spent to buy fifty life points in an action game. In another embodiment, user 12 may convert fifty sport zone activity minutes into currency that can be spent to buy strength in a combat game. In another embodiment, user 12 may convert primary metric activity to purchase the ability to play arcade games from a third party site. Users 12 want to succeed in video games so translation driven games 70 create an incentive for users to engage in physical activity so that users 12 can obtain more digital currency.

Capture the flag can be a translation driven game 70. Capture the flag involves two teams. A team wins when one team successfully grabs the opposing team's flag and returns it to team's own flag. Users can convert primary metric activity into special abilities or special guns.

Site Warz is an interactive game that is both a passive and active driven variable game. Site warz is similar to the board game Risk™. Site Warz is a continuous game that never ends. Site Warz has a map, and the map changes periodically. At the end of the period, the gaming environment 60 reports results for the month. Users 12 don't have to sign up for this game to be a part of it so that is the passive variable driven game aspect. For example, there may be 20 sites on the map. Company A may have 900 employees. These 900 employees generate a number of activity monitor points per day. Each site is worth a different amount of points based on the number of employees, such that some sites are worth more than other sites. A company will receive the number of points per day for the total amount of points the sites are worth that the company controls. If only 100 of the 900 employees of Company A are using an activity monitor for that day, then Company A must decide how many of the 100 employees should attack, where the employees should attack, and how many employees should defend the site in case another company attacks their site. Site Warz is a big strategy game for taking over sites and defending the sites you currently control. Similarly, there can be a company vs. company game. These types of massive multiplayer user games will increase companies to motivate employees to be active because companies want to out compete other companies.

Mission games (which can be included within passive variable driven game module 62 or provided separately) are similar to passive variable driven games 62 created by the operators of the interactive community 30 except that user 12 is only competing against himself. A mission game can challenge user 12 to achieve a goal in a specified period. If user 12 accepts the mission and completes the mission, then user 12 may receive a unique customizable skin only obtainable by completing the specific mission. User 12 may also receive experience points, a trophy 92, or a reward 92. For example, a mission may appear in December for user 12 to travel a distance of fifty miles by January. If user 12 completes this mission, user 12 may obtain a reward. For example, one type of reward can be a skin. A skin is operable to change the layout of a user's website. A skin is an alternate layout for the way user's website is displayed, such that anything about how the website looks can be changed including colors, background, images, overall layout, and anything else on user's website. For example, a Christmas skin for the user's website may change the user's website to a Christmas layout, such that borders are candy canes, default colors become red, green, and white, web page appears as if snow is falling, and any other possible change to website layout. Users 12 will engage in physical activity to create a unique display of their personal website. Rewards may also include movie themes, video game themes, sporting team themes, backgrounds, transitions, wall paper, and special effects. These rewards are discussed in more detail below.

User created game mods can also be implemented by users on the website. User created game mods can be written from scratch or user created game mods can customize an existing game like head to head, free for all, capture the flag, tug of war, marathon, king of the hill, housewife, celebrity race, and site warz. Gaming environment will provide users the predefined functions for games, such that users can successfully create game mods based on these game types.

Communication environment 80 comprises a plurality of user web pages. The user web pages include displays and features in interactive community 30 that utilizes data from an activity monitor 14. Some, but not all, of these features and tools are illustrated in FIG. 2. In this non-limiting example, the features include: user progress 82, group progress 84, messages from other users 86, instant messages from other users 87, leader boards 88, friends 90, trophy case 92, participate in game 94, challenge other users to game 96, CGUI 98, activity zones 100, news feed 102, instructional media 104, and goals 106. Leader boards 88 can include global rank, specific game rank, global level, specific game level, group rank, group level, population rank, population level, and any other suitable statistic. Proprietary algorithms can determine a user's experiences points 214, level 216, global rank 216, and specific game rank 216, and any other suitable statistic. Each of these items are explained in greater detail below.

Friend's scroller can be displayed on a user's webpage. Friend's scroller displays one or more thumbnail pictures of user's friends. User can drag and drop pictures from friend's scroller into games, emails, messages, groups, etcetera. User can also click on thumbnail picture to access the friend's website.

User's progress 82 can be displayed on a user's webpage. The displays showing user's progress 82 include a graph, activity zones 100, goals 106, calories burned, daily points, rank, and level. For example, a graph may be a bar graph where the horizontal axis includes the months of the year and the vertical axis includes total calories burned. The graph display is customizable to include other data on the vertical axis and other time periods on the horizontal axis. Additionally, users 12 can create groups 108 of users 12 and a population of users 12. The progress of a group of users 12 or a population of users 12 can also be displayed on a user's website. A group of users 12 is one or more users 12. A population of users 12 is one or more groups of users 12. Users 12 can track their progress in several different ways and see immediate results which creates an incentive for users to sustain their physical activity.

Goals 106 are a feature to be displayed on a user's website or activity monitor. Users 12 can set goals 106 based on personal performance. Goals 106 can be set for one or more primary metrics over a specified period of time. A primary metric can include steps, distance, calories, points, life zone minutes, health zone minutes, or sport zone minutes. Personal goals 106 of user are saved to server 32. For example, if user 12 sets goal 106 to walk ten miles in one week, then this will be displayed on the user's website. Every time that activity monitor 14 is coupled to a computer device 16, activity monitor 14 transmits all of the primary metric data to interactive community 30 which continuously updates the status of personal goals 106. For example, if user 12 walks two miles during the specified time period, then interactive community 30 will update user's goal 106 such that the updated status of goal 106 will be displayed on the user's website. User 12 can transmit the status of goal 106 to computer device 16, user's email, another user 12, or activity monitor 14. User 12 can track the progress of every personal goal 106 displayed on activity monitor 14, email, user's website, or computing device 16. User 12 will have more incentive to engage in physical activity by being able to continuously track the status of user's personal goals 106.

Activity zones 100 are a feature to be displayed on a user's website and on activity monitor. Both activity monitor 14 and interactive community 30 are operable to convert data from activity monitor 14 into one of three activity zones: life zone minutes include stationary activity with light physical activity; health zone minutes include moderate physical activity; and sports zone minutes include heavy physical activity. Activity zones 100 relate directly to primary metric information and MET units. A MET unit is the energy expenditure at rest, equivalent to an oxygen uptake of approximately 3.5 ml of oxygen per kilogram body weight per minute. Server 32 calculates and saves the activity zone data for an individual user 12, a group of users 12, and a population of users 12. A group of users 12 includes one or more users 12, such that groups can have specific traits and similarities. For example, groups can include schoolmates, company members, competitive people, family members, friends, gaming enthusiasts, moms over fifty years old, and any other possible group that might connect people together. A population of users 12 includes one or more groups. For example, in a physical education class in an elementary school, a student is an individual user 12. The group of users 12 includes other students in the student's same class. The population of users 12 includes all of the students enrolled in physical education classes in the entire school. Interactive community 30 will display both the primary metric's unit of measurement and the duration of time accumulated in the life zone, health zone, and sports zone. This data can be displayed for an individual user 12, a group of users 12, or a population of users 12.

Trophy case 92 is a feature to be displayed on a user's website or activity monitor. Trophies and rewards 92 are awarded for both personal achievements and competitive achievements. User 12 may receive trophy or reward 92 for personal achievements by achieving personal goals. User 12 may receive trophy or reward 92 for competitive achievements based on performance. Trophies and rewards 92 may be digitally displayed on the user's webpage. Trophies and rewards 92 may also be tangible. Reward 92 may include a customizable skin for display on the user's webpage, discounts on consumer products, unlocking a hidden game, digital currency for use in translation driven games 70, and tangible gifts. For example, user 12 may receive trophy or reward 92 for achieving their personal goal 106, winning ten consecutive games, achieving a top ten rank, reaching level twenty, or obtaining a high score. Users 12 will engage in more physical activity and sustain the physical activity because of user's 12 satisfaction with trophies and rewards 92. Users 12 can view trophy case 92 of other users 12 so users 12 will also engage in more physical activity to try and accumulate more trophies and rewards 92 than other users 12.

Users 12 can send messages 110 to other users and receive messages from other users. Messages 86 may be displayed as an inbox or as a post on a message board on the user's website. Additionally, users 12 can send instant messages 110 to other users and receive instant messages from other users 12. A chat box may pop up to display the conversation of the instant messages 87 between users 12. Users 12 have an incentive to dock their activity monitor 14 more often so that users 12 can communicate with their friends.

Leader board 88 is a feature to be displayed on a user's website or activity monitor. Several versions of leader boards 88 can be displayed including leader boards 88 for global rank, specific game rank, global level, specific game level, group rank, group level, population rank, and population level. Leader board 88 can be for individuals, groups, companies, or based on specific game types. For example, user 12 can display leader board 88 for the group including women over the age of fifty. Users 12 will have an incentive to be physically active because they can compete against their peers of the same sex and age. Leader board 88 may include tabs or other means operable to sort by rank 504, user name 506, level 508, total points 510, average points 512, days activity monitor has been worn 514, percentage of games won 516, health zone daily average 518, life zone daily average 520, sports zone daily average 520, date of the last time user docked the activity monitor 522, current streak 524, and longest streak 526. The leader board 88 is operable for user 12 to click on the tabs to sort the information.

Proprietary algorithms utilizing one or more primary metric variables will decide a user's experiences points 214, level 216, global rank 216, and specific game rank 216. In one embodiment, an algorithm utilizes variables and achievements to determine a user's experience points 214, level 216, global rank 216, and specific game rank 216. Variables include: i) win, loss, or tie record (and placement for free for all games); ii) recent streak of winning, losing, or tying; iii) the total points accumulated on a particular embodiment of activity monitor 14; iv) the average points accumulated per day on a particular embodiment of activity monitor 14; v) the total days activity monitor 14 is worn; vi) the percentage of days activity monitor 14 is worn; vii) the total life zone minutes accumulated such that life zone minutes include stationary activity with light physical activity; viii) the average life zone minutes accumulated per day; ix) the total health zone minutes accumulated such that health zone minutes include moderate physical activity; x) the average health zone minutes accumulated per day; xi) the total sports zone minutes accumulated such that sports zone minutes include heavy physical activity; xii) the average sports zone minutes accumulated per day; xiii) the last day activity monitor 14 was docked; xiv) the current streak of activity monitor 14 being worn; xv) the longest streak of activity monitor 14 being worn. Achievements include: i) beating or losing to user 12 or team with a level or rank much higher than your level or rank; ii) winning or losing several games in a row; iii) beating or losing to another user or team by several points; iv) finishing a game faster than any other user; v) scoring more points than any other user; vi) docking activity monitor 14 frequently; vii) including several people in your friends, family, and rivals list; viii) defeating friends, family, and rivals; ix) placing consecutively high or low in a free for all game; x) participating in a large number of games; xi) starting or joining several groups; xii) sending several messages to other users 12; xiii) receiving several messages from other users 12; xiv) posting many comments to other users 12; xv) gaining community status; xvi) uploading a personal picture to user's website; xvii) modifying user's website; xviii) creating a game; xix) joining a user created game; xx) completing additional defined experiences like missions; and xxi) the rankings of user 12 in passive variable driven games 66. For example, user 12 may be the best at a specific game and obtain a number one rank for that specific game. However, user 12 may not have a similar global rank if the user is not good at other specific games or does not dock activity monitor 14 or does not send many messages 110 to other users 12 in interactive community 30, etc. In another example, a level thirty user 12 will not receive many experience points by defeating a level two user 12 because the level thirty user 12 was expected to win. However, if the level two user 12 defeats the level thirty user 12, then the level two user 12 will gain a significant amount of experience points while the level thirty user 12 loses a significant amount of experience points. Users 12 will become competitive in their ranking and level which will cause users 12 to become more physically active and sustain that activity.

Users 12 can create and display their user profile. A user profile may include a personal picture, age, sex, weight, height, location, biography, and interests. The detailed information in the user profile makes it possible for algorithms to calculate customized results based on age, sex, weight, and height. The detailed information in the user profile also allows users to search for other users based on similar age, sex, weight, height, location, or interests. Users 12 can choose to have their profile public or private. For example, if a user's profile is private, then the user will not show up in another user's search results looking for a female of age thirty located in Dallas, Tex.

Users 12 can invite friends and display pictures of their friends on their website. Users 12 can choose to have their profile viewable to only other users 12 on their friend's list or user 12 can choose to have their profile viewable by everyone in the interactive community 30. Users 12 can also challenge 96 another user to a game or participate in a game already created. User 12 can challenge 96 any other user to any game. Challenges 96 can include an instant message conversation 87 so that users 12 can discuss the challenge further. The other user 12 can decline or accept the challenge 96. User 12 can also join games 94 already created in gaming environment 60.

Users 12 can shop at online stores 172 via the website. Users 12 can store information on the website, such that buying products through an online store will be seamless without requiring users to enter extra information. For example, activity monitor automatically connects user 12 to web portal, and user 12 can automatically connect to an online store 172 without having to type in username, password, or credit card information. Web portal 40 can communicate with value added reseller websites. Web portal 40 can also display customized advertisements to users 12, because the advertisements can have access to user's personal information including age, height, weight, sex, location, and interests, etcetera. For example, specific ads can appear for a 45 year old woman that would not appear for a 25 year old male.

Web portal 40 can use activity monitor data with insurance claim data to report financial efficacy to companies. ICD9 codes and CPT4 codes are used to convey this information. The information used may include social security number, amount billed, amount paid, class code (for example employee, spouse, number of children, etcetera), date, age, gender, CPT4 codes, ICD9 codes, and provider. Pharmaceutical data is also gathered that may include social security number, amount billed, amount paid, class code (for example employee, spouse, number of children, etcetera), date, brand name of medication, type of medication, generic or brand, and provider. The previous information is collected from insurance carriers. In order to user information effectively, web portal also needs company census data directly from the company. The information required directly from the company may include user's ID (for example, social security number), user's age or date of birth, user's gender, and number of months user has been eligible for the plan within the plan year. Web portal can deliver these reports to customers like companies. For example, on a quarterly basis, web portal 40 can e-mail statistics to companies stating how many people are wearing the activity monitor within the company, and how many people aren't wearing the activity monitor within the company. These groups can be divided up, such that the group wearing activity monitors is costing $1,000, and the group not wearing activity monitors is costing $1,000,000. A company can look at this report every month or every quarter in the mail or as often as the utilization data is updated. The activity reports are sent seamlessly to companies. This reporting feature create an incentive for companies to require employees to wear activity monitors, which will encourage employees to be active.

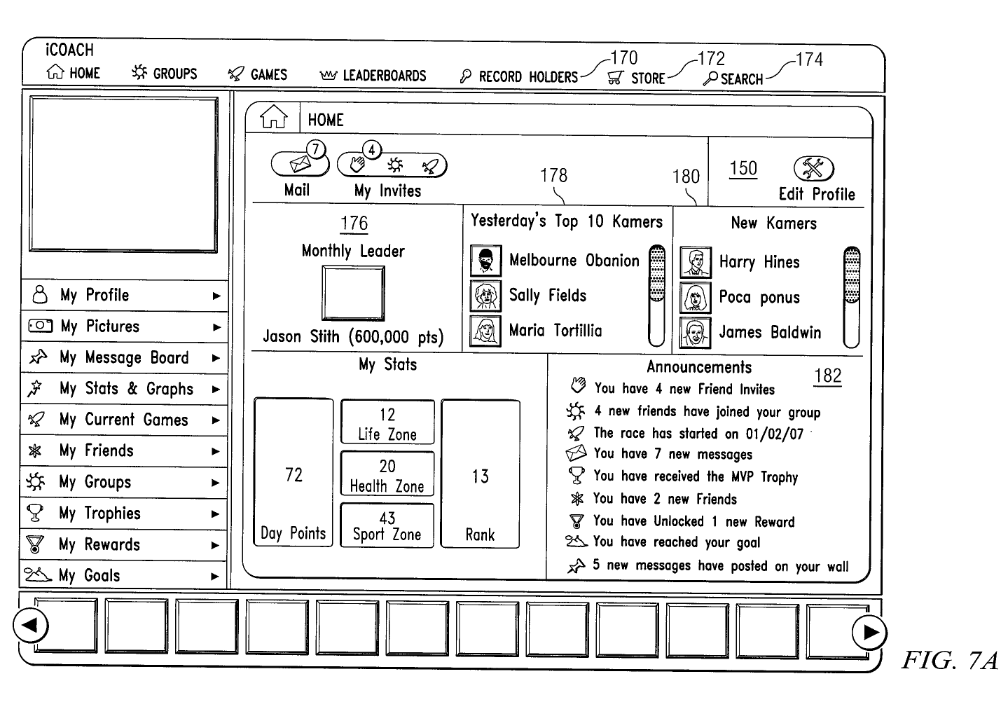

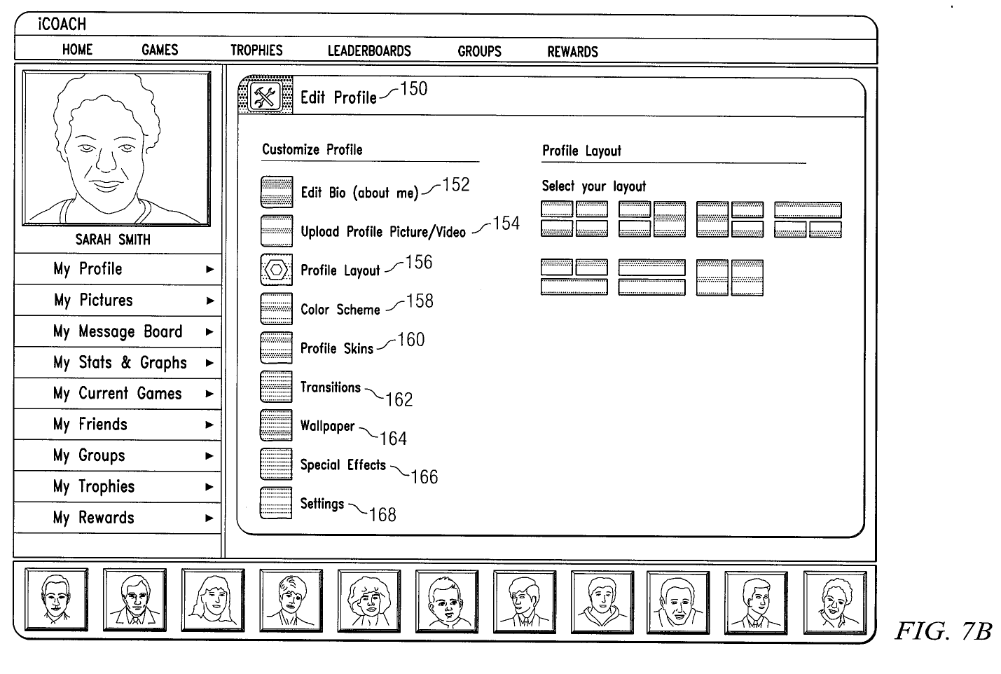

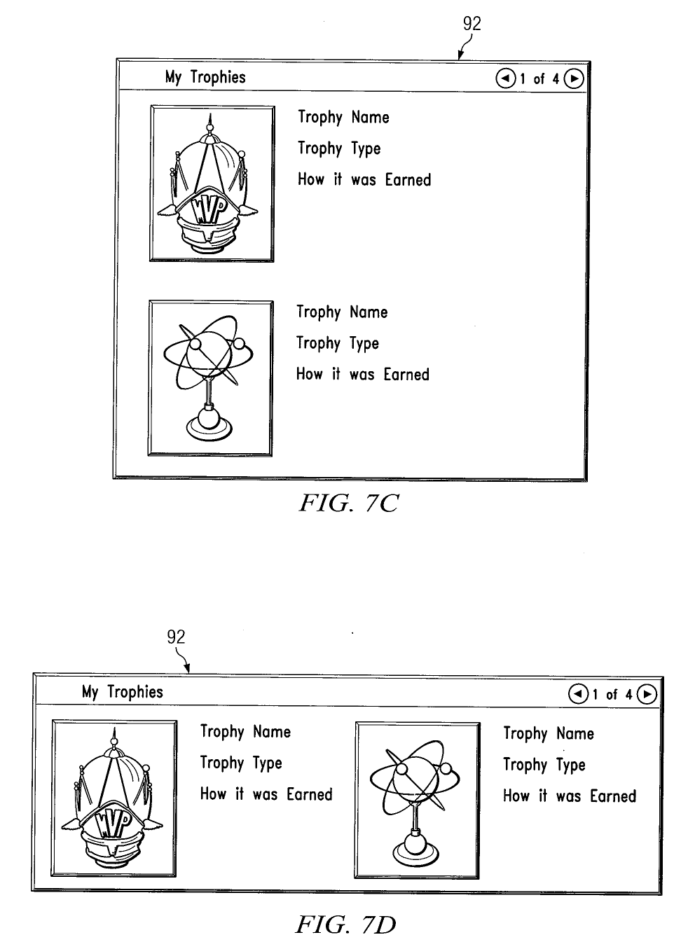

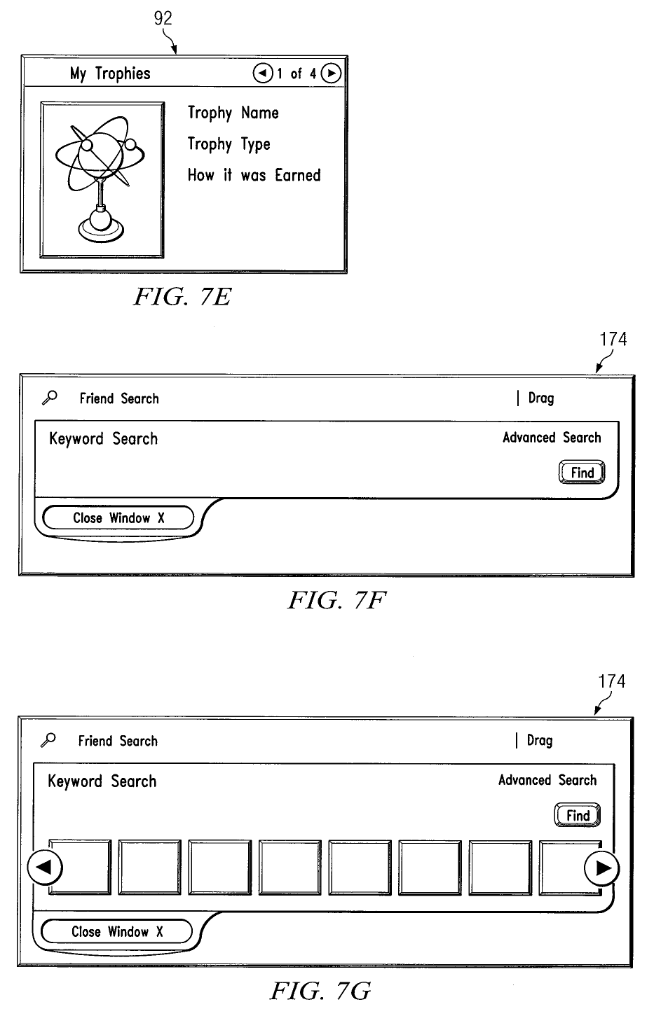

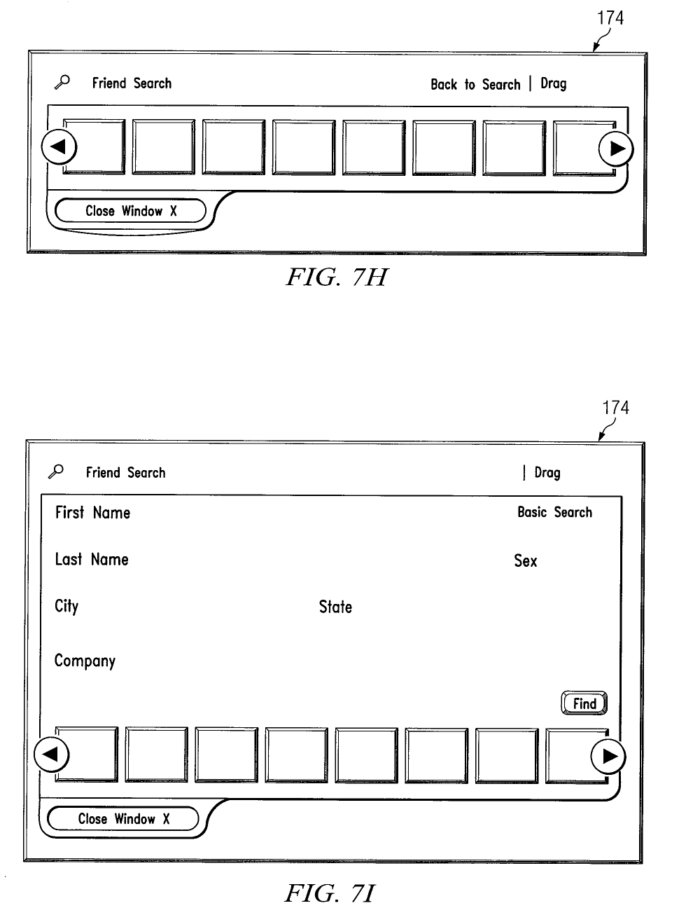

Users 12 can search for friends 174 who have profiles on web portal. When a user clicks on a search function, then a pop-up search function 174 appears over the actual website. The search function 174 allows users 12 to type in basic keyword searches or advanced searches. For example, user 12 may search for a friend's last name, and all users 12 on the web portal 40 can appear as a friend's list as seen in FIGS. 7G and 7H. User 12 can click on one of the picture in the friend's list, such that the friend's profile would appear. User 12 can also use the scroll function on the friend's list to scroll through different friend's pictures included in the search. User 12 can also move the search function 174 around on the website since the search function is overlaying the website, such that user 12 can place the search function on an area of the website that is not distracting user 12 from viewing the website. The search function is capable of being placed on the outside of the website as well, such that only a portion of the search function is visible within the website. The search function can perform searches based on anything including first name, last name, zip code, interests, key phrases, city, state, company, etcetera. For example, users may want to search for other users interested in rollerblading and users can type in rollerblading to find all the friends on the web portal who also enjoy rollerblading. This functionality allows users to seek out friends with similar activity interests, such that users become more active. The search function can be displayed in different embodiments as seen in FIGS. 7F, 7G, 7H, and 7I. After a search is complete, search function 174 is operable to automatically minimize to a smaller version displaying only pictures of friends included in the search.

News feed 102 is a feature that can be displayed on a user's website, activity monitor 14, or any computer device 16. News feeds 102 include audio, text, and video formats from various sources. User 12 can play news feed 102 in a variety of ways including streaming the data over communication network 18, downloading news feed 102 to a computing device 16, or saving news feed 102 on interactive community 30 to play at a later time. User 12 can also transmit news feed 102 to other users 12. The content of news feeds 102 can be displayed according to a user's workouts or health plan. The content of news feeds 102 can also be customized based on a user's preferences. For example, user 12 who has diabetes will receive news feeds 102 relating to diabetes.

Instructional media (for example, instructional videos) 104 represent a feature that can be displayed on a user's website. The content of instructional videos 104 include a guide of how to use activity monitor 14, a guide of how to use interactive community 30, workout information, nutritional information, health information, and motivational techniques. User 12 can play the instructional video in a variety of ways including streaming the data over communication network 18, downloading instructional video 104 to computing device 16, or saving the instructional video on the interactive community 30 to play at a later time. User can also transmit instructional video 104 to other users 12. Instructional media 104 can include different media forms, including audio, text, and Pod cast.

Record holders 170 is a feature to be displayed on a user's website. Users 12 can set records based on personal performance. Users 12 can set records for almost every conceivable statistic including current leader belt holder, all-time leader belt holder, all-time longest winning streak, all-time longest losing streak, current longest winning streak, current longest losing streak, most points in a day, most total points, most friends, most king of the hill wins, most tug of war wins, most messages sent, most days activity monitor has been worn, newest member, oldest member, all-time most health zone minutes, all-time most life zone minutes, all-time most sport zone minutes, most calories burned in a day, all-time most calories burned, all-time most time spent on website, all-time most advertisements clicked, etcetera. Record holders can be for any possible statistic for the day, week, month, year, or all-time. The website homepage may feature a leader belt holder 176 for the month so that users 12 have incentive to reach this position. For example, when a user logs on, user can see the monthly leader 176 and how many points the leader belt holder has, such that users will need to increase activity to beat the monthly leader 176. Users 12 can track the progress of every record displayed on activity monitor 14, email, user's website, or computing device 16. User 12 will have more incentive to engage in physical activity by being able to continuously track the status of user's records 106. Users will have more incentive to challenge established records, such that users will become more active.

Yesterday's top point leaders 178 is a feature to be displayed on a user's website. Yesterday's top point leaders 178 may can display the top three, top five, or top ten point leaders, etcetera. Users 12 will have more incentive to challenge top point leaders and have their own picture displayed on the website, such that users will become more active.

New users 180 is a feature to be displayed on a user's website. New users 180 displays the pictures of new users on the website to introduce new users to the interactive community.

Announcements 182 is a feature to be displayed on a user's website. Announcements 182 display messages that convey information of user's activities. See FIG. 7A for examples of announcements 182.

Users 12 can create and utilize a customizable graphic user interface (“CGUI”) 98 to create customizable websites. CGUI 98 allows users to display how features are displayed and where features are displayed on their website. For example, a doctor may create CGUI 98 to display different features on the website than a website of a physical education teacher. CGUI 98 also allows users 12 to modify the graphical displays on their website by using customizable skins. For example, a customizable skin for the user's website may make the user's webpage appear as if snow is falling.

Edit Profile 150 allows users to customize user bios 152, upload pictures and videos 154, profile layouts 156, color schemes 158, profile skins 160, transitions 162, wallpaper 164, special effects 166, and privacy settings 168. Customized displays can also include sporting team themes, video game themes, and movie themes. Edit profile utilizes widgets. Examples of widgets are illustrated in FIGS. 7B, 7C, 7D, and 7E. Widgets are similar to bricks, and users can put them on their website or exchange them out for different types of widgets. Widgets can be shapes as horizontal, vertical, or square. Widgets can be expanded and minimized to becomes larger or smaller depending on user's preferences. Widgets can display any type of feature offered by interactive community. For example, one user 12 may choose to place a square widget bio on the top, left portion of user's website. Another user 12 may choose to place a vertical widget trophy case on the top, left portion of user's website. Another user 12 may choose not to include the widgets for a trophy case or bio on user's website. Users can customize their websites using the widgets. This allows the web pages in web portal to look somewhat uniform, but unique for each user 12. If a user does not want to customize user's webpage, then a randomized webpage layout of widgets is created.

User's bio 152 is a feature to be displayed on a user's website. User's bio 152 displays information entered by user about user.

Uploading user's pictures and videos 154 is a feature to be displayed on a user's website. Uploading user's pictures and videos 154 allow user's to display a unique picture or video of how user wants to be displayed to other users.

Profile layouts 156 is a feature to be displayed on a user's website. Profile layouts 156 allow users to select the type of widget layout to create a unique website customized to user's preferences. See FIG. 7B for an illustration of Profile layouts. 156

Color schemes 158 is a feature to be displayed on a user's website. Color schemes allow users to select the type of colors that are present throughout their website to create a unique website customized to user's preferences. Interactive community will automatically randomly assign color patterns for men and color patterns for women, such that user's websites have unique displays. Color schemes can fade and shift throughout the website.

profile skins 160 are a feature to be displayed on a user's website. A skin 160 is operable to change the layout of a user's website. A skin 160 is an alternate layout for the way user's website is displayed, such that anything about how the website looks can be changed including colors, background, images, overall layout, and anything else on user's website. For example, a Christmas skin for the user's website may change the user's website to a Christmas layout, such that borders are candy canes, default colors become red, green, and white, web page appears as if snow is falling, and any other possible change to website layout. Users can also purchase skins 160 for money. Users 12 will engage in physical activity to create a unique display of their personal website.

Transitions 162 are a feature to be displayed on a user's website. Transitions 162 occur when user clicks on a new page, such that transitions are an animation occurring during this process. For example, transitions 162 may have a Halloween transition and spiders can run across user's website.

Wallpaper 164 is a feature to be displayed on a user's website. Wallpaper 164 is the background area around the perimeter of user's website. Wallpaper works similarly to skins and color schemes. Wallpaper can have opacity and designs associated with it, and users can choose the unique coloring, designs, and opacity for user's website.

Special effects 166 are a feature to be displayed on a user's website. Special effects can be any extra added display to make user's webpage more unique. For example, Christmas lights hanging down from the top of user's website can be a special effect. Another example of a special effect can be stadium lights mounted on user's website shining light down upon user's website. Another special effect can include the mouse pointer being a knife and being able to slash the site. Another special effect can include a water ripple effect on the user's website every time user clicks or moves mouse pointer.

Customized display themes are a feature to be displayed on user's website. Customized display themes can include sporting team themes, video game themes, and movie themes. By using a theme, then all of the edit profile options can be selected to fit within the theme. For example, if user selects Dallas Cowboys™ theme, then color scheme can be silver and blue, profile skin can involve stars and footballs, transitions can be a player running across the page, wallpaper can be dark blue, and special effects can have stadium lights mounted on website. Similarly, movie theme can include a Rocky™ theme or a video game theme can include a Doom™ theme.

Privacy settings 168 are a feature to be displayed on user's website. Privacy settings determine whether other users can view your profile, pictures, message board, statistics, graphs, friends, groups, trophies, rewards, and goals, etcetera. Users can select public or private for each individual display. For example, user can allow friends to see trophies, but not their goals.

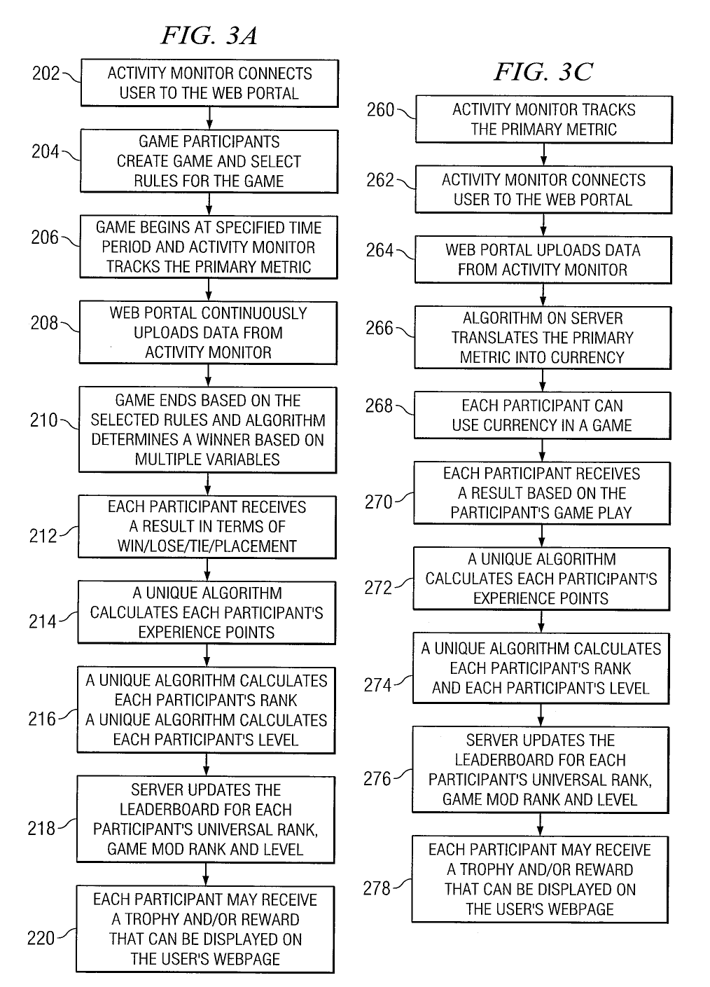

FIG. 3A is a simplified flowchart that illustrates an example method of an active variable driven game 64 in accordance with an embodiment of the present invention. The example process begins at step 202 where user 12 couples activity monitor 14 to computer device 16 such that user 12 can access web portal 40 in interactive community 30 without intervention from a third party (for example, a webmaster forwarding information). Activity monitor 14 functions as a digital key to web portal 40 so that users 12 instantly access web portal 40 without having to launch an Internet web browser or type in a username or password. User 12 will be able to instantly interact with other users 12 in gaming 60 and communication environment 80.

At step 204, user 12 creates active variable driven games 64 through web portal 40. Users 12 can invite other users 12 to join the game or users 12 can join the game on their own. Users 12 set rules and select a specified time period of when the game will begin and when the game will end. For example, the rules can include the first user 12 to reach 1,000 steps, burn 500 calories, or run a mile in the shortest time.

At step 206, active variable driven game 64 begins at the start of the specified time period and finishes at the end of the specified time period. User participation begins when user 12 wears activity monitor 14. Activity monitor 14 is operable to track one or more primary metrics, store the primary metrics, and transmit the primary metrics to gaming environment 60. The web portal continuously uploads data from activity monitor, as reflected by step 208.

At step 210, active variable driven game 64 ends at the expiration of the specified time period. Activity monitor 14 transmits all of the primary metric data to gaming environment 60. One or more proprietary algorithms utilize each user's primary metrics to decide a result of variable driven game 64.

At step 212, results can include win, place, tie, or placement. Results can include win, place, or tie for team-versus-team games and one-versus-one games. A team can be one or more users 12. Results can include a placement result for a free-for-all game involving a plurality of users 12 or teams competing against one another. For example in a free-for-all game of nine teams, the team that finishes first will receive a first placement and the team that finishes ninth will have a ninth placement.

At step 214, one or more proprietary algorithms utilizing one or more primary metric variables will decide a user's experiences points 214, level 216, global rank 216, and specific game rank 216. In one embodiment, an algorithm utilizes variables and achievements to determine a user's experience points 214, level 216, global rank 216, and specific game rank 216. Variables include: i) win, loss, or tie record (and placement for free for all games); ii) recent streak of winning, losing, or tying; iii) the total points accumulated on a particular embodiment of an activity monitor 14; iv) the average points accumulated per day on a particular embodiment of activity monitor 14; v) the total days activity monitor 14 is worn; vi) the percentage of days activity monitor 14 is worn; vii) the total life zone minutes accumulated such that life zone minutes include stationary activity with light physical activity; viii) the average life zone minutes accumulated per day; ix) the total health zone minutes accumulated such that health zone minutes include moderate physical activity; x) the average health zone minutes accumulated per day; xi) the total sports zone minutes accumulated such that sports zone minutes include heavy physical activity; xii) the average sports zone minutes accumulated per day; xiii) the last day activity monitor was docked; xiv) the current streak of activity monitor 14 being worn; xv) the longest streak of activity monitor 14 being worn. Achievements include: i) beating or losing to a user 12 or team with a level or rank much higher than your level or rank; ii) winning or losing several games in a row; iii) beating or losing to another user 12 or team by several points; iv) finishing a game faster than any other user; v) scoring more points than any other user; vi) docking activity monitor 14 frequently; vii) including several people in your friends, family, and rivals list; viii) defeating friends, family, and rivals; ix) placing consecutively high or low in a free for all game; x) participating in a large number of games; xi) starting or joining several groups; xii) sending several messages 110 to other users; xiii) receiving several messages from other users; xiv) posting many comments to other users; xv) gaining community status; xvi) uploading a personal picture to user's website; xvii) modifying user's website; xviii) creating a game; xix) joining a user created game 94; xx) completing additional defined experiences like missions; and xxi) the rankings of user in the passive variable driven games 66. For example, user 12 may be the best at a specific game and obtain a number one rank for that specific game. However, user 12 may not have a similar global rank if the user is not good at other specific games or does not dock activity monitor 14 or does not send many messages 110 to other users 12 in interactive community 30, etcetera. In another example, a level thirty user 12 will not receive many experience points by defeating a level two user 12 because the level thirty user 12 was expected to win. However, if the level two user 12 defeats the level thirty user 12, then the level two user 12 will gain a significant amount of experience points while the level thirty user 12 loses a significant amount of experience points.

At step 218, interactive community 30 updates leader board 88 for each user's experience points, global rank, specific game rank, and level. At step 220, user 12 may receive trophy or reward 92 or both based on performance. Trophies and rewards 92 may be digitally displayed on the user's webpage. Trophies and rewards 92 may also be tangible. Reward 92 may include a customizable skin for display on the user's webpage, discounts on consumer products, unlocking a hidden game, digital currency for use in translation driven games, and tangible gifts. For example, user 12 may receive trophy or reward 92 for winning ten consecutive games, achieving a top ten rank, reaching level twenty, or obtaining a high score.

FIG. 3B is a simplified flowchart that illustrates an example method of passive variable driven game 66 in accordance with an embodiment of the present invention. The example process begins at step 240 where user 12 couples activity monitor 14 to computer device 16 such that user 12 can access web portal 40 in interactive community 30 without intervention from a third party (for example, a webmaster forwarding information). Activity monitor 14 functions as a digital key to web portal 40 so that users 12 instantly access web portal 40 without having to launch an Internet web browser or type in a username or password. User 12 will be able to instantly interact with other users in gaming 60 and communication environment 80.

At step 242, passive variable driven game 66 begins at a specified time and activity monitor 14 tracks a primary metric. A primary metric can include steps, distance, calories, points, life zone minutes, health zone minutes, and sport zone minutes. The interactive community 30 is operable to automatically create passive variable driven games 66. Users 12 can also create passive variable games 66 through web portal 40. Step 244 simply reflects that a game can end at a predetermined time. The specified time period in passive variable game 66 usually comprises a day, week, month, or year. At the end of the specified time period, a rank will be given for each user 12 based on the primary metric totals. For example, passive variable driven game 66 may last for six months based on the total number of calories burned. User 12 who burns 120,000 calories during the six month period will receive a better rank than user 12 who burns 90,000 calories during the six month period.

At step 246, web portal uploads data from activity monitor. At step 248, each participant receives a rank based on the participant's primary metric. Interactive community 30 updates leader board 88 for each user's experience points, global rank, specific game rank, and level.

At step 250, user 12 may receive trophy or reward 92 or both based on performance. Trophies and rewards 92 may be digitally displayed on the user's webpage. Trophies and rewards 92 may also be tangible. Reward 92 may include a customizable skin for display on the user's webpage, discounts on consumer products, unlocking a hidden game, digital currency for use in translation driven games, and tangible gifts. For example, user 12 may receive trophy or reward 92 for winning ten consecutive games, achieving a top ten rank, reaching level twenty, or obtaining a high score.

FIG. 3C is a simplified flowchart that illustrates an example method of translation driven 70 game in accordance with an embodiment of the present invention. The example process begins at step 260 where user 12 is physically active while wearing activity monitor 14 so that one or more primary metrics are stored in the activity monitor's memory.

At step 262, user 12 couples an activity monitor 14 to computer device 16 such that user 12 can access the web portal in interactive community 30 without intervention from a third party (for example, a webmaster forwarding information). Activity monitor 14 functions as a digital key to web portal 40 so that users instantly access web portal 40 without having to launch an Internet web browser or type in a username or password. User 12 will be able to instantly interact with other users 12 in gaming 60 and communication environment 80.

At step 264, activity monitor 14 transmits all of the primary metric data to gaming environment 60. At step 266, translation driven games 70 utilize data from activity monitor 14 such that user 12 can convert a primary metric from activity monitor 14 into a digital currency for user 12 to utilize in gaming environment 60. The digital currency is a stored data value that can be utilized in gaming environment 60. At step 268, the digital currency can be spent on gaming elements to help user 12 succeed in gaming environment 60. For example, user 12 may convert 1,000 calories burned into currency that can be spent to buy fifty gallons of gasoline for a race car game. In another embodiment, user 12 may convert fifty steps into currency that can be spent to buy fifty life points in an action game. In another embodiment, user 12 may convert fifty sport zone activity minutes into currency that can be spent to buy strength in a combat game.

At step 270, results can include points, win, place, tie, or placement based on a user's game play. At step 272, one or more proprietary algorithms utilizing one or more primary metric variables will decide a user's experiences points 214, level 216, global rank 216, and specific game rank 216. In one embodiment, an algorithm utilizes variables and achievements to determine a user's experience points 214, level 216, global rank 216, and specific game rank 216. Variables include: i) win, loss, or tie record (and placement for free for all games); ii) recent streak of winning, losing, or tying; iii) the total points accumulated on a particular embodiment of an activity monitor 14; iv) the average points accumulated per day on a particular embodiment of activity monitor 14; v) the total days activity monitor is worn; vi) the percentage of days activity monitor 14 is worn; vii) the total life zone minutes accumulated such that life zone minutes include stationary activity with light physical activity; viii) the average life zone minutes accumulated per day; ix) the total health zone minutes accumulated such that health zone minutes include moderate physical activity; x) the average health zone minutes accumulated per day; xi) the total sports zone minutes accumulated such that sports zone minutes include heavy physical activity; xii) the average sports zone minutes accumulated per day; xiii) the last day activity monitor 14 was docked; xiv) the current streak of activity monitor 14 being worn; xv) the longest streak of activity monitor 14 being worn. Achievements include: i) beating or losing to user 12 or team with a level or rank much higher than your level or rank; ii) winning or losing several games in a row; iii) beating or losing to another user 12 or team by several points; iv) finishing a game faster than any other user 12; v) scoring more points than any other user 12; vi) docking activity monitor 14 frequently; vii) including several people in your friends, family, and rivals list; viii) defeating friends, family, and rivals; ix) placing consecutively high or low in a free for all game; x) participating in a large number of games 94; xi) starting or joining several groups; xii) sending several messages 110 to other users 12; xiii) receiving several messages from other users; xiv) posting many comments to other users; xv) gaining community status; xvi) uploading a personal picture to user's website; xvii) modifying user's website; xviii) creating a game; xix) joining a user created game 94; xx) completing additional defined experiences like missions; and xxi) the rankings of a user in the passive variable driven games 66. For example, user 12 may be the best at a specific game and obtain a number one rank for that specific game. However, user 12 may not have a similar global rank if user 12 is not good at other specific games or does not dock activity monitor 14 or does not send many messages 110 to other users in interactive community 30, etcetera. In another example, a level thirty user 12 will not receive many experience points by defeating a level two user 12 because the level thirty user 12 was expected to win. However, if the level two user 12 defeats the level thirty user 12, then the level two user 12 will gain a significant amount of experience points while the level thirty user 12 loses a significant amount of experience points.

At step 274, an algorithm calculates each participant's rank and level. At step 276, interactive community updates the leader board 88 for each user's experience points, global rank, specific game rank, and level. At step 278, user 12 may receive a trophy or reward 92 or both based on performance. Trophies and rewards 92 may be digitally displayed on the user's webpage. Trophies and rewards 92 may also be tangible. Reward 92 may include a customizable skin for display on the user's webpage, discounts on consumer products, unlocking a hidden game, digital currency for use in translation driven games, and tangible gifts. For example, user 12 may receive a trophy or reward 92 for winning ten consecutive games, achieving a top ten rank, reaching level twenty, or obtaining a high score.

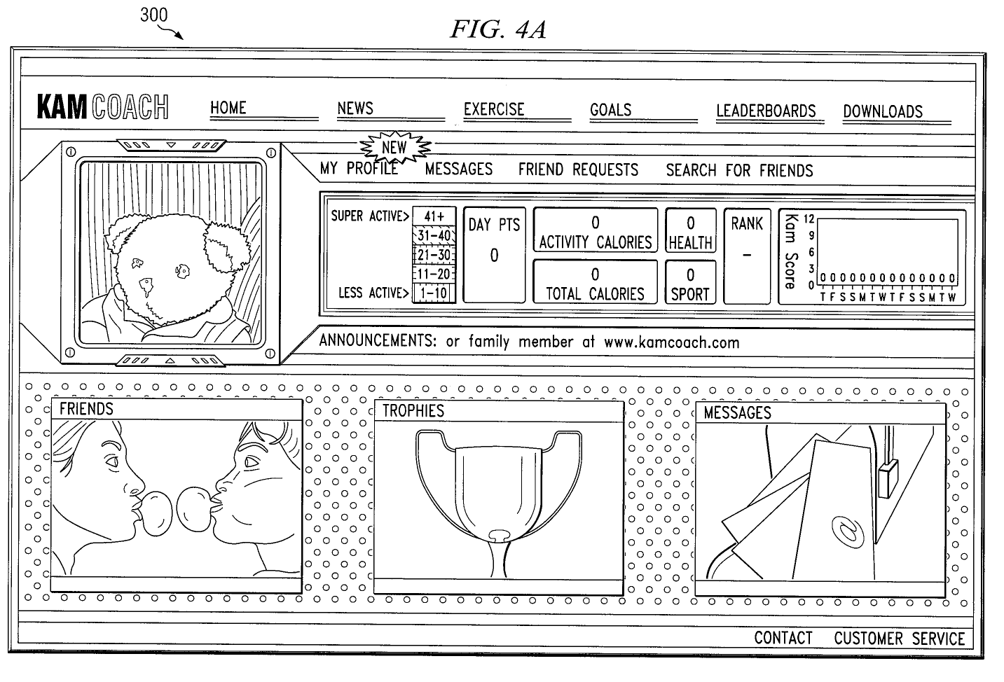

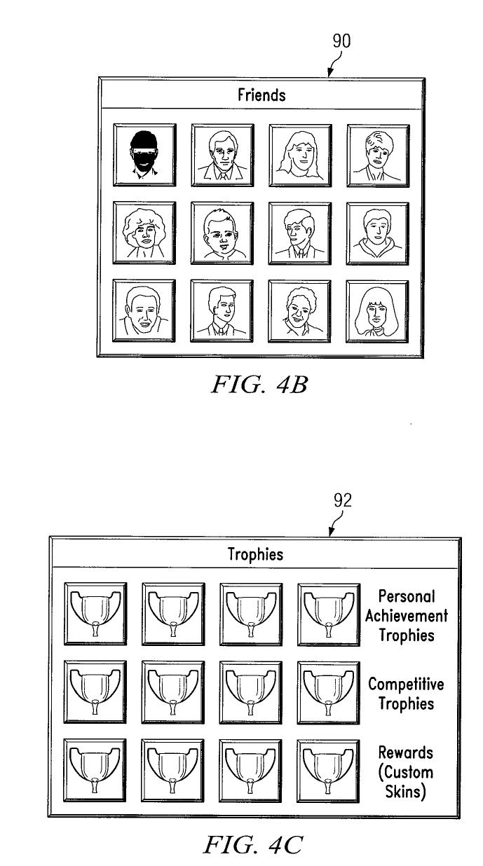

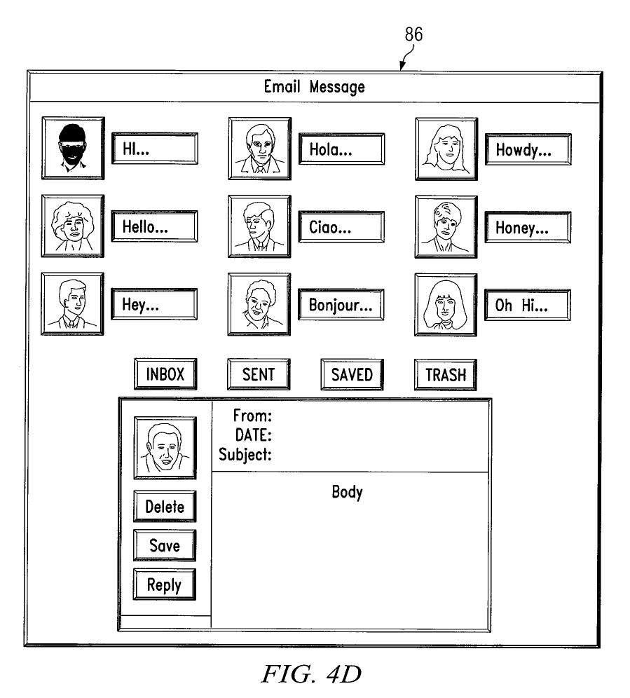

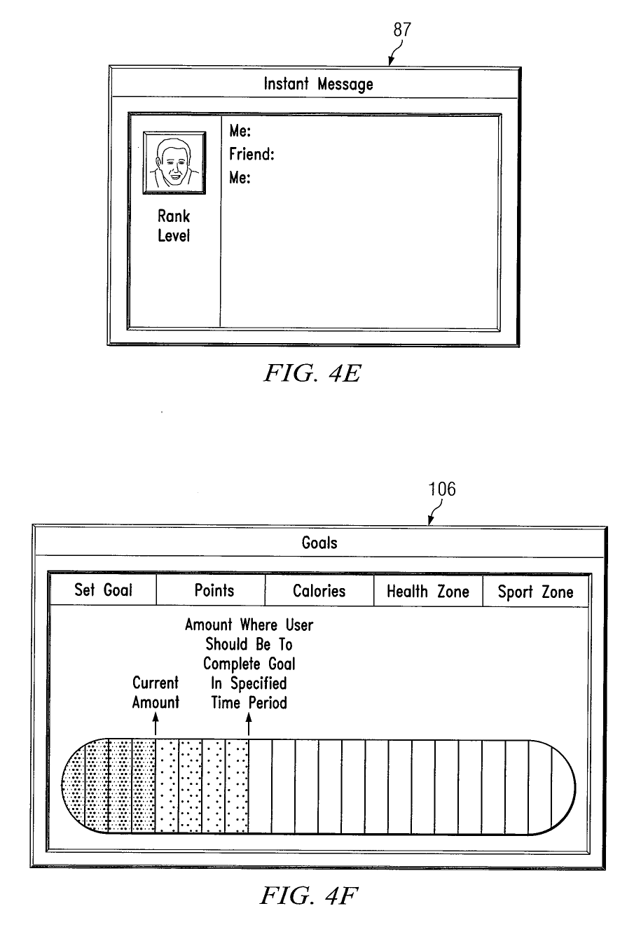

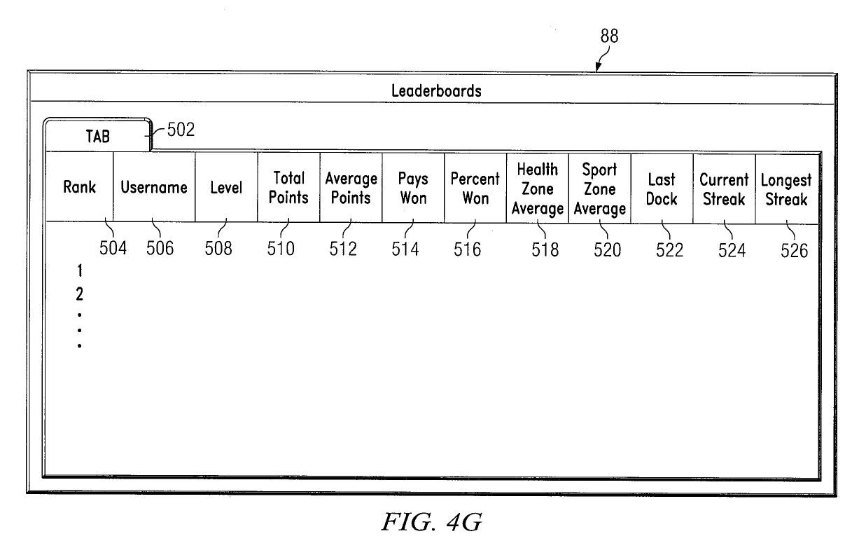

FIG. 4A is an example of a user's website 300 in accordance with an embodiment of the present invention. The top row of tabs includes home, news, exercise, goals, leader boards, and downloads. The center left picture is a personal picture selected by the user. The middle row of tabs includes profile, messages, invite friends, and search for friends. The middle area includes a daily points, activity calories, total calories, health zone minutes, sports zone minutes, global rank, a graph, and a scrolling announcement bar. The bottom row includes a friend's list, a trophy case, and an inbox for messages. The bottom right area includes contact information and customer service. FIG. 7A is another example of a user's website. The website layout can be customized by users to display widgets of different sizes and types.

FIG. 4B is an example of a friends feature 90, first introduced in FIG. 2, which can be displayed on a user's website in accordance with an embodiment of the present invention. Personal pictures of friends are displayed in rows and columns.

FIG. 4C is an example of a trophy case 92, first introduced in FIG. 2, which can be feature displayed on a user's website in accordance with an embodiment of the present invention. One area of the trophy case 92 displays digital trophies for personal achievements. One area of the trophy case 92 displays digital trophies for competitive achievements. One area of the trophy case 92 displays rewards like customizable skins that the user has received.

FIG. 4D is an example of a message feature 86, first introduced in FIG. 2, which can be displayed on a user's website in accordance with an embodiment of the present invention. The middle tabs allow a user to look at the inbox, sent messages, saved messages, and trashed messages. The message 86 in box can display rows and columns of a small personal picture of the sender of the email along with a small text box of the message's contents. Upon clicking on one of the miniature messages, a larger version is displayed with a personal picture. The fields from, date, subject are included in the header of the message and the body of the message is included below. The user has the option to delete, save, or reply to the message 86.

FIG. 4E is an example of an instant message feature 87, first introduced in FIG. 2, which can be displayed on a user's website in accordance with an embodiment of the present invention. A personal picture of the other user is displayed along with the user's rank, level, and other profile information. The body of the instant message 87 includes messages from each user.

FIG. 4F is an example of a goal feature 106, first introduced in FIG. 2, which can be displayed on a user's website in accordance with an embodiment of the present invention. The top row of tabs includes a tab to create a goal 106 and one or more tabs of the goals 106 the user 12 has created including points, calories, health zone, and spots zone. Points can take the form of Kinetic Activity Monitor points. Upon clicking on a particular goal already created, a graphic is displayed indicating the current amount accumulated, the amount where the user should be at to stay on pace with the goal 106, and the remaining amount left for the user 12 to accomplish.

FIG. 4G is an example of a leader board 88, first introduced in FIG. 2, which can be displayed on a user's website in accordance with an embodiment of the present invention. A tab allows a user 12 to select a type of leader board 88 to display including leader boards for global rank, specific game rank, global level, specific game level, global group rank, group level, population rank, and population level. The remaining tabs are sort able including rank, user name, level, total points, average points, days activity monitor 14 has been worn, percentage of games won, health zone daily average, life zone daily average, sports zone daily average, date of the last time user 12 docked the activity monitor 14, current streak, and longest streak.

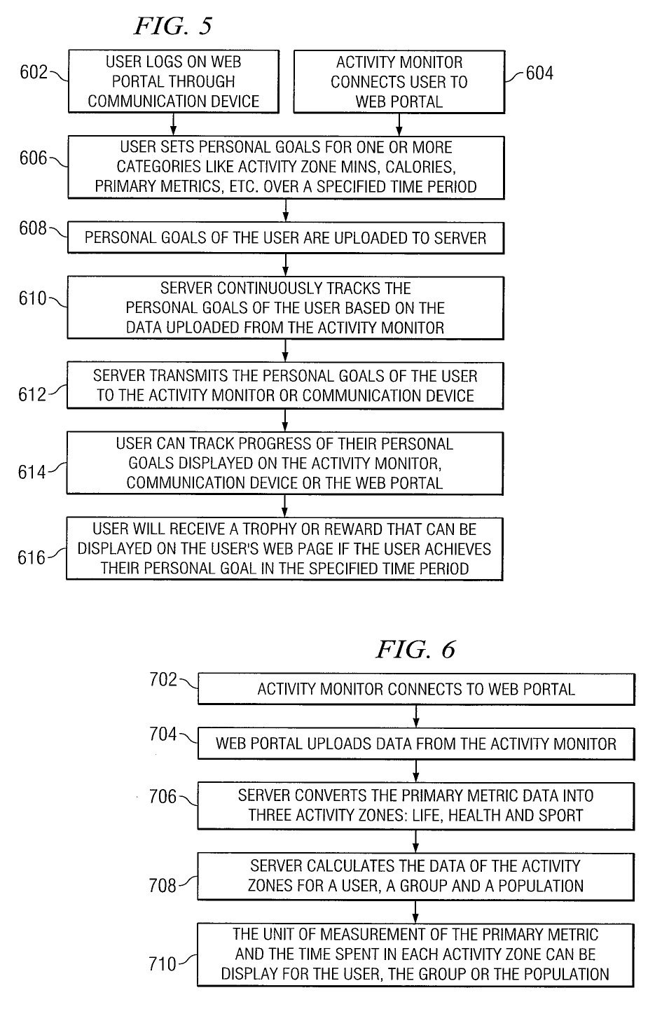

FIG. 5 is a simplified flowchart that illustrates an example method of goal 106 feature in accordance with an embodiment of the present invention. The example process begins at step 602 where user 12 couples activity monitor 14 to a computer device 16 such that user 12 can access web portal 40 in interactive community 30 without intervention from a third party (for example, a webmaster forwarding information). Activity monitor 14 functions as a digital key to web portal 40 so that users 12 instantly access web portal 40 without having to launch an Internet web browser or type in a username or password. User 12 will be able to instantly interact with other users 12 in gaming 60 and communication environment 80. In a possible alternative the example process begins at step 604 where activity monitor 14 is operable to access web portal 40 in interactive community 30 without coupling to computer device 16.

At step 606, users 12 can set goals 106 based on personal performance. Goals 106 can be set for one or more primary metrics over a specified period of time. A primary metric can include rank, steps, distance, calories, points, life zone minutes, health zone minutes, sport zone minutes, counter data, or game statistics. Users can track At step 608, personal goals 106 of user 12 are saved to server 32. For example, if user 12 sets goal 106 to walk ten miles in one week, then goal 106 can be displayed on the user's website.

At step 610, every time that activity monitor 14 is coupled to computer device 16, activity monitor 14 transmits all of the primary metric data to interactive community 30 which continuously updates the status of personal goals 106. For example, if user 12 walks two miles during the specified time period, then interactive community 30 will update user's goal 106 such that the updated status of goal 106 will be displayed on the user's website.

At step 612, user 12 can transmit the status of goal 106 to computer device 16, the user's email, another user 12, or activity monitor 14. At step 614, user 12 can track the progress of every personal goal 106 displayed on activity monitor 14, email, user's website, or computing device 16. For example, user can track the progress of user's rank displayed on activity monitor 14, email, user's website, or computing device 16. User 12 will have more incentive to engage in physical activity by being able to continuously track the status of user's personal goals 106.

At step 616, user 12 may receive trophy or reward 92 or both based on performance. Trophies and rewards 92 may be digitally displayed on the user's webpage and activity monitor. Trophies and rewards 92 may also be tangible. Reward 92 may include a customizable skin for display on the user's webpage, discounts on consumer products, unlocking a hidden game, digital currency for use in translation driven games, and tangible gifts. For example, user 12 may receive a trophy or reward 92 for achieving ten consecutive personal goals.

FIG. 6 is a simplified flowchart that illustrates an example method of activity zones 100 feature in accordance with an embodiment of the present invention. The example process begins at step 702 where user 12 couples activity monitor 14 to computer device 16 such that user 12 can access web portal 40 in interactive community 30 without intervention from a third party (for example, a webmaster forwarding information). Activity monitor 14 functions as a digital key to web portal 40 so that users 12 instantly access the web portal 40 without having to launch an Internet web browser or type in a username or password. User 12 will be able to instantly interact with other users 12 in gaming 60 and communication environment 80.

At step 704, activity monitor 14 transmits all of the primary metric data to gaming environment 60. At step 706, activity monitor 14 is operable to store data from activity monitor 30 into one of three activity zones 100: life zone minutes include stationary activity with light physical activity; health zone minutes include moderate physical activity; sports zone minutes include heavy physical activity. Activity zones 100 relate directly to primary metric information and MET units. A MET unit is the energy expenditure at rest, equivalent to an oxygen uptake of approximately 3.5 ml of oxygen per kilogram body weight per minute.

At step 708, server 32 saves the activity zone data for an individual user 12, and compiles activity zone data for a group of users 12 and a population of users 12. A group of users 12 includes one or more users 12. A population of users 12 includes one or more groups. For example, in a physical education class in an elementary school, a student is an individual user 12. The group of users 12 includes other students in the student's same class. The population of users 12 includes all of the students enrolled in physical education classes in the entire school. At step 710, interactive community 30 will display both the primary metric's unit of measurement and the duration of time accumulated in the life zone, health zone, and sports zone. This data can be displayed for an individual user 12, a group of users 12, or a population of users 12.

It is important to note that the stages and steps described above illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within interactive community 30 to effectuate the tasks and operations of the elements and activities associated with executing compatibility functions.

FIG. 7A is an example of a user's website, first introduced in FIG. 2, in accordance with an embodiment of the present invention. This embodiment of user's website displays tabs across the top of website including home, groups, games, leader boards, record holders, store, and search for friends. Website further displays a square widget displaying monthly leader, a square widget displaying yesterday's top point leaders, a square widget displaying new users, a horizontal widget displaying statistics, and a horizontal widget displaying announcements. Left border of website further displays user's picture or video, profile, pictures, message board, statistics and graphs, current games, friends, groups, trophies, rewards, and goals. Bottom of website displays friend's list with the friend's scroller.

FIG. 7B is an example of an edit profile feature 150, first introduced in FIG. 2, which can be displayed on a user's website in accordance with an embodiment of the present invention. This embodiment allows user to customize user's website by selecting edit bio, upload profile picture or video, profile layout, color schemes, profile skins, transitions, wallpaper, special effects, and settings.

FIG. 7C is an example of a vertical widget of a trophy case feature 42, first introduced in FIG. 2, which can be displayed on a user's website in accordance with an embodiment of the present invention. This embodiment allows a user to display a vertical widget on the user's website displaying a trophy case 42.

FIG. 7D is an example of a horizontal widget of a trophy case feature 42, first introduced in FIG. 2, which can be displayed on a user's website in accordance with an embodiment of the present invention. This embodiment allows a user to display a horizontal widget on the user's website displaying a trophy case 42.

FIG. 7E is an example of a square widget of a trophy case feature 42, first introduced in FIG. 2, which can be displayed on a user's website in accordance with an embodiment of the present invention. This embodiment allows a user to display a square widget on the user's website displaying a trophy case 42.

FIG. 7F is an example of a search feature 174, first introduced in FIG. 2, which can be displayed on a user's website in accordance with an embodiment of the present invention. This embodiment allows a user to enter a keyword search to find friends. The user can click on advanced search to search for more specific terms.

FIG. 7G is an example of a search feature 174, first introduced in FIG. 2, which can be displayed on a user's website in accordance with an embodiment of the present invention. This embodiment allows a user to enter a keyword search to find friends. The user can click on advanced search to search for more specific terms. The bottom of the search feature displays a friends list with a friend's scroller to scroll through friends that were within the search results.

FIG. 7H is an example of a search feature 174, first introduced in FIG. 2, which can be displayed on a user's website in accordance with an embodiment of the present invention. This embodiment of the search feature displays a friends list with a friend's scroller to scroll through friends that were within the search results. The user can click on back to search to start another search.

FIG. 7I is an example of a search feature 174, first introduced in FIG. 2, which can be displayed on a user's website in accordance with an embodiment of the present invention. This embodiment allows a user to enter an advanced search to find friends. The advanced search includes search fields for last name, first name, sex, city, state, and company. The user can click on basic search to search for more general terms. The bottom of the search feature displays a friends list with a friend's scroller to scroll through friends that were within the search results.

Although the present invention has been described in detail with reference to particular embodiments, it should be understood that various other changes, substitutions, and alterations may be made hereto without departing from the spirit and scope of the present invention. The illustrated network architecture of FIG. 1 has only been offered for purposes of example and teaching. Suitable alternatives and substitutions are envisioned and contemplated by the present invention: such alternatives and substitutions being clearly within the broad scope of communication system 10. For example, the use of the LAN could easily be replaced by a virtual private network (VPN), a metropolitan area network (MAN), a wide area network (WAN), a wireless LAN (WLAN), or any other element that facilitates data propagation. Using analogous reasoning, the computer device illustrated by FIG. 1 may be supplanted by docking stations, gaming consoles, or any other suitable devices that are conducive to network communications. Furthermore, the web site design is not confined to the example display layouts shown in FIG. 4A, FIG. 4B, FIG. 4C, FIG. 4D, FIG. 4E, FIG. 4F, FIG. 4G, FIG. 7A, FIG. 7B, FIG. 7C, FIG. 7D, FIG. 7E, FIG. 7F, FIG. 7G, FIG. 7H, and FIG. 7I.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for an interactive online community, comprising:
operating one or more servers coupled to a communication network providing access to the World Wide Web, wherein the network is operable to communicate with an activity monitor, and wherein the activity monitor is operable to measure data and transmit and receive the data; and
providing a web portal located on one or more servers, the web portal operable to transmit data to the activity monitor and receive data from the activity monitor, wherein the web portal includes a gaming and communication environment, and wherein the gaming and communication environment utilize the data from the activity monitor, whereby a user is enabled to participate in the gaming and communication environment with other users.

2. The method of claim 1, wherein the data from the activity monitor is a primary metric, the primary metric being a selected metric of a group of metrics, the group consisting of:
a) calories;
b) distances;
c) activity monitor points;
d) steps;
e) life zone minutes;
f) health zone minutes;
g) sports zone minutes;
h) game statistics; and
i) counter data.

3. The method of claim 1, wherein the activity monitor links to a computer device connected to a communication network.

4. The method of claim 3, wherein the activity monitor automatically logs the user into the web portal.

5. The method of claim 2, wherein the server utilizes an algorithm to convert the primary metric into a digital currency, wherein the user utilizes the currency in the gaming environment.

6. The method of claim 5, wherein the user converts the currency into one or more game elements in the gaming environment, the game elements consisting of:
a) gasoline in a car racing game;
b) life points in an action game;
c) strength in a combat game; and
d) special powers in a fantasy game.

7. The method of claim 4, wherein the gaming environment enables users to compete with other users and select rules for a game.

8. The method of claim 7, wherein the web portal receives data from one or more activity monitors while the users participate in the game.

9. The method of claim 8, wherein the server utilizes an algorithm to determine a result in terms of win, lose, tie, or placement based on data from the activity monitor.

10. The method of claim 2, wherein the gaming environment enables a user to participate in a game that begins at a specified time and ends at a specified time.

11. The method of claim 1, wherein the user may receive one or more rewards at the end of a game, the rewards consisting of:
a) displaying a customizable skin on the user's webpage;
b) discounts on consumer products;
c) unlocking a new game;
d) digital currency; and
e) tangible gifts.

12. The method of claim 1, wherein the user may receive one or more trophies at the end of a game.

13. The method of claim 1, wherein the server utilizes one or more algorithms to calculate a user's rank, experience points, and level at the end of a game.

14. The method of claim 1, wherein the communication environment is a plurality of user web pages.

15. The method of claim 14, wherein each user webpage is operable to display one or more user chosen features in different sizes and in different locations on the webpage, the features consisting of:
a) a display of a user's progress;
b) a display of a group's progress;
c) a display for messages;
d) a display for instant messages;
e) a display for friends;
f) a display for a leader board;
g) a display for a trophy case;
h) a display for activity zones;
i) a display for goals;
j) a display to participate in a game;
k) a display for a news feed;
l) a display for instructional media;
m) a display for creating a profile, a group, or a customizable graphical user interface;
n) a display for record holders;
o) a display for an online store;
p) a display for searching for friends;
q) a display for pictures and videos;
r) a display for color schemes;
s) a display for skins;
t) a display for transitions;
u) a display for wallpaper;
v) a display for special effects;
w) a display for privacy settings;
x) a display for profile layout;
y) a display for monthly leader;
z) a display for yesterday's top users;
aa) a display for new users; and
bb) a display for announcements.

16. The method of claim 15, wherein the leader board displays one or more features, the features consisting of:
a) a rank;
b) a username;
c) a level;
d) total points;
e) average points;
f) days worn;
g) percent won;
h) health zone average;
i) sports zone average;
j) life zone average;
k) last dock;
l) current streak; and
m) longest streak.

17. The method of claim 16, wherein the leader board is for a universal ranking, a specific game ranking, or a universal level.

18. The method of claim 16, wherein the server utilizes an algorithm to determine the rank of a user on the leader board.

19. The method of claim 16, wherein the server utilizes an algorithm to determine the level of a user on the leader board.

20. The method of claim 15, wherein the user can create a profile, one or more groups, one or more goals for one or more categories, and a customizable graphical user interface.

21. The method of claim 20, wherein the customizable graphical user interface is operable to use customizable skins and to customize the way features of the user webpage are displayed.

22. The method of claim 15, wherein the categories of a goal may include distances, life zone minutes, health zone minutes, sports zone minutes, or calories.

23. The method of claim 15, wherein the web portal continuously updates the one or more goals of the user based on the data received from the activity monitor.

24. The method of claim 15, wherein the web portal transmits the updates of the one or more goals of the user to the activity monitor or computer device.

25. The method of claim 15, wherein the user may receive a trophy or reward upon the user achieving a goal.

26. The method of claim 15, wherein the activity zones include a life zone, a sports zone, and a health zone.

27. The method of claim 26, wherein the server utilizes an algorithm to convert the data from the activity monitor into data for the life zone, the sports zone, and the health zone.

28. The method of claim 26, wherein the user website further displays an activity zone for a user, a group, and a population.

29. The method of claim 14, wherein the user can transmit and receive messages and instant messages to other users.

30. A system for an interactive online community, comprising:
an activity monitor, wherein the activity monitor is operable to measure data and to transmit and receive data;
one or more servers coupled to a communication network providing access to the World Wide Web;
a web portal located on one or more servers, the web portal operable to transmit data to the activity monitor and receive data from the activity monitor, wherein the web portal includes a gaming and communication environment, wherein the gaming and communication environment utilize the data from the activity monitor; and
one or more users, wherein the one or more users participate in the gaming and communication environment with other users.

31. The system of claim 30, wherein the data from the activity monitor is a primary metric, the primary metric being a selected metric of a group of metrics, the group consisting of:
a) calories;
b) distances;
c) activity monitor points;
d) steps;
e) life zone minutes;
f) health zone minutes;
g) sports zone minutes;
h) game statistics; and
i) counter data.

32. The system of claim 30, wherein the activity monitor links to a computer device connected to a communication network.

33. The system of claim 32, wherein the activity monitor automatically logs the user into the web portal.

34. The system of claim 31, wherein the server utilizes an algorithm to convert the primary metric into a digital currency, wherein the user utilizes the currency in the gaming environment.

35. The system of claim 34, wherein the user converts the currency into one or more game elements in the gaming environment, the game elements consisting of:
a) gasoline in a car racing game;
b) life points in an action game;
c) strength in a combat game; and
d) special powers in a fantasy game.

36. The system of claim 33, wherein the gaming environment enables users to compete with other users and select rules for a game.

37. The system of claim 36, wherein the web portal receives data from one or more activity monitors while the users participate in the game.

38. The system of claim 37, wherein the server utilizes an algorithm to determine a result in terms of win, lose, tie, or placement based on data from the activity monitor.

39. The system of claim 31, wherein the gaming environment enables a user to participate in a game that begins at a specified time and ends at a specified time.

40. The system of claim 30, wherein the user may receive one or more rewards at the end of a game, the rewards consisting of:
a) displaying a customizable skin on the user's webpage;
b) discounts on consumer products;
c) unlocking a new game;
d) digital currency; and
e) tangible gifts.

41. The system of claim 30, wherein the user may receive one or more trophies at the end of a game.

42. The system of claim 30, wherein the server utilizes one or more algorithms to calculate a user's rank, experience points, and level at the end of a game.

43. The system of claim 30, wherein the communication environment is a plurality of user web pages.

44. The system of claim 43, wherein each user webpage is operable to display one or more user chosen features in different sizes and in different locations on the webpage, the features consisting of:
a) a display of a user's progress;
b) a display of a group's progress;
c) a display for messages;
d) a display for instant messages;
e) a display for friends;
f) a display for a leader board;
g) a display for a trophy case;
h) a display for activity zones;
i) a display for goals;
j) a display to participate in a game;
k) a display for a news feed;
l) a display for instructional media;
m) a display for creating a profile, a group, or a customizable graphical user interface;
n) a display for record holders;
o) a display for an online store;
p) a display for searching for friends;
q) a display for pictures and videos;
r) a display for color schemes;
s) a display for skins;
t) a display for transitions;
u) a display for wallpaper;
v) a display for special effects;
w) a display for privacy settings;
x) a display for profile layout;
y) a display for monthly leader;
z) a display for yesterday's top users;
aa) a display for new users; and
bb) a display for announcements.

45. The system of claim 44, wherein the leader board displays one or more features, the features consisting of:
a) a rank;
b) a username;
c) a level;
d) total points;
e) average points;
f) days worn;
g) percent won;
h) health zone average;
i) sports zone average;
j) life zone average;
k) last dock;
l) current streak; and
m) longest streak.

46. The system of claim 45, wherein the leader board is for a universal ranking, a specific game ranking, or a universal level.

47. The system of claim 45, wherein the server utilizes an algorithm to determine the rank of a user on the leader board.

48. The system of claim 45, wherein the server utilizes an algorithm to determine the level of a user on the leader board.

49. The system of claim 44, wherein the user can create a profile, one or more groups, one or more goals for one or more categories, and a customizable graphical user interface.

50. The system of claim 49, wherein the customizable graphical user interface is operable to use customizable skins and to customize the way features of the user webpage are displayed.

51. The system of claim 44, wherein the categories of a goal may include distances, life zone minutes, health zone minutes, sports zone minutes, or calories.

52. The system of claim 44, wherein the web portal continuously updates the one or more goals of the user based on the data received from the activity monitor.

53. The system of claim 44, wherein the web portal transmits the updates of the one or more goals of the user to the activity monitor or computer device.

54. The system of claim 44, wherein the user may receive a trophy or reward upon the user achieving a goal.

55. The system of claim 44, wherein the activity zones include a life zone, a sports zone, and a health zone.

56. The system of claim 55, wherein the server utilizes an algorithm to convert the data from the activity monitor into data for the life zone, the sports zone, and the health zone.

57. The system of claim 55, wherein the user website further displays an activity zone for a user, a group, and a population.

58. The system of claim 43, wherein the user can transmit and receive messages and instant messages to other users.
